(19) United States
(12) Patent Application Publication
(10) Pub. No.: US 2026/0281888 A1
(43) Pub. Date: Sep. 17, 2026

(54) NETWORK SLICE REPLACEMENT WITH MULTI-ACCESS DELIVERY

(71) Applicant: Samsung Electronics Co., Ltd., Suwon-si (KR)

(72) Inventor: Prakash Reddy Kolan, Plano, TX (US)

(21) Appl. No.: 19/556,969

(22) Filed: Mar. 4, 2026

Related U.S. Application Data
(60) Provisional application No. 63/771,384, filed on Mar. 13, 2025.
(60) Provisional application No. 63/837,391, filed on Jul. 2, 2025.

(51) Int. Cl. H04W 48/18; H04W 8/20

(52) U.S. Cl. CPC H04W 48/18; H04W 8/20

(57) ABSTRACT

A method for network slice replacement with multi-access delivery includes receiving information indicating replacement of a current network slice, and determining or receiving a configuration for a replacement network slice for carrying a multi-access (MA) protocol data unit (PDU) session of a user equipment (UE). The method also includes, based on the configuration for the replacement network slice, replacing the current network slice with an alternate network slice to carry the MA PDU session.

### CROSS-REFERENCE TO RELATED APPLICATIONS AND CLAIM OF PRIORITY

This application claims priority under 35 U.S.C. § 119(e) to U.S. Provisional Patent Application No. 63/771,384 filed on Mar. 13, 2025, and U.S. Provisional Patent Application No. 63/837,391 filed on Jul. 2, 2025. The above-identified provisional patent applications are hereby incorporated by reference in their entirety.

### TECHNICAL FIELD

This disclosure relates generally to wireless networks. More specifically, this disclosure relates to network slice replacement with multi-access delivery.

### BACKGROUND

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included in a given device is increasing. Even with the increase of processing power, portable electronic devices often struggle to provide the processing capabilities to handle new services and applications, as newer services and applications often require more resources than are included in a portable electronic device. Improved methods and apparatuses for configuring and deploying media processing in the network are desirable.

Cloud media processing is gaining traction where media processing workloads are setup in the network (e.g., cloud) to take advantage of benefits offered by the cloud such as (theoretically) infinite compute capacity, auto-scaling based on demand, and on-demand processing. An end user client can request a network media processing provider for provisioning and configuration of media processing functions.

### SUMMARY

This disclosure provides apparatuses and methods for network slice replacement with multi-access delivery, for example in networks such as 5G networks.

In one embodiment, a method for network slice replacement with multi-access delivery is provided. The method includes receiving information indicating replacement of a current network slice, and determining or receiving a configuration for a replacement network slice for carrying a multi-access (MA) protocol data unit (PDU) session of a user equipment (UE). The method also includes, based on the configuration for the replacement network slice, replacing the current network slice with an alternate network slice to carry the MA PDU session.

In another embodiment, an electronic device is provided. The electronic device includes at least one processor including processing circuitry, and memory storing instructions. The instructions, when executed by the at least one processor individually or collectively, cause the electronic device to receive information indicating replacement of a current network slice, and determine or receive a configuration for a replacement network slice for carrying an MA PDU session of a UE. The instructions, when executed by the at least one processor individually or collectively, also cause the electronic device to, based on the configuration for the replacement network slice, replace the current network slice with an alternate network slice to carry the MA PDU session

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIGS. 2 and 3 illustrate example electronic devices according to embodiments of the present disclosure;

FIG. 4 illustrates an example 5GMS architecture according to embodiments of the present disclosure;

FIG. 5 illustrates an example Application Function influenced network slice replacement according to embodiments of the present disclosure;

FIG. 6 illustrates an example UE subscription of network slices according to embodiments of the present disclosure;

FIG. 7 illustrates an example of network slice configuration of service parameters according to embodiments of the present disclosure;

FIG. 8 illustrates an example of multi-access delivery according to embodiments of the present disclosure;

FIG. 9 illustrates an example network slice replacement for a network slice carrying an MA PDU Session according to embodiments of the present disclosure;

FIG. 10 illustrates an example procedure for network slice replacement with a network slice carrying an MA PDU Session according to embodiments of the present disclosure;

FIG. 11 illustrates an example procedure for network slice replacement with multi-slice setup according to embodiments of the present disclosure;

FIG. 12 illustrates an example procedure to switch to an MA PDU Session upon request to enable multi-access delivery according to embodiments of the present disclosure;

FIG. 13 illustrates an example procedure for network recommendation to stay in or switch a current network slice to enable multi-access delivery according to embodiments of the present disclosure

FIG. 14 illustrates another example procedure to switch to an MA PDU Session upon request to enable multi-access delivery according to embodiments of the present disclosure;

FIG. 15 illustrates an example procedure for mapping external service slices to internal UE slices according to embodiments of the present disclosure;

FIG. 16 illustrates an example procedure for network slice replacement based on mapping information from external service slices to internal UE slices according to embodiments of the present disclosure;

FIG. 17 illustrates an example procedure for network slice replacement based on network slice subscription groups according to embodiments of the present disclosure;

FIG. 18 illustrates an example of a default network slice configuration for network slice replacement according to embodiments of the present disclosure;

FIG. 19 illustrates an example procedure for OAM provisioned/configured network slice for slice replacement according to embodiments of the present disclosure;

FIG. 20 illustrates an example procedure for an application service provider configured network slice for slice replacement according to embodiments of the present disclosure;

FIG. 21 illustrates an example procedure for network slice replacement based on network slice subscription groups based on configuration information from an application service provider according to embodiments of the present disclosure;

FIG. 22 illustrates an example procedure for an application service provider configured network slice for slice replacement according to embodiments of the present disclosure; and

FIG. 23 illustrates an example method for network slice replacement with multi-access delivery according to embodiments of the present disclosure.

### DETAILED DESCRIPTION

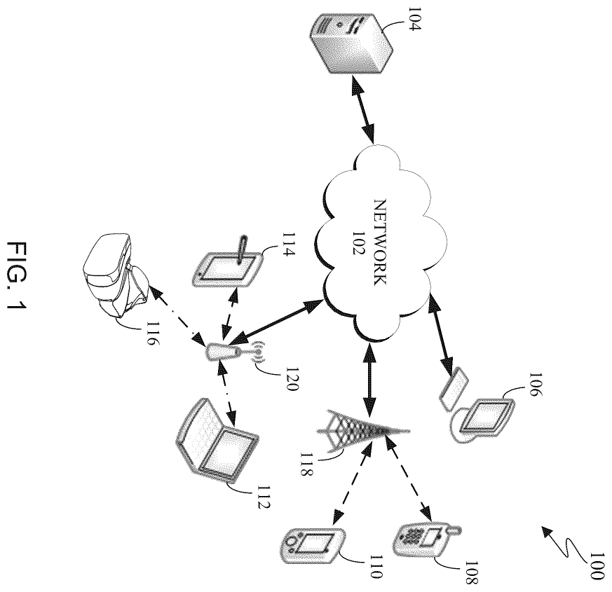

FIGS. 1 through 23, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. A client device may also be referred to herein as a user equipment (UE). Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations, eNodeBs (eNBs), or gNodeBs (gNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in the present disclosure can be used, these features could be used in any other suitable system.

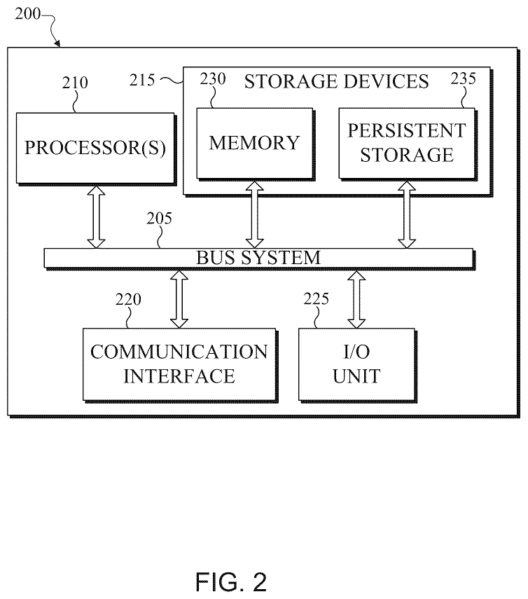

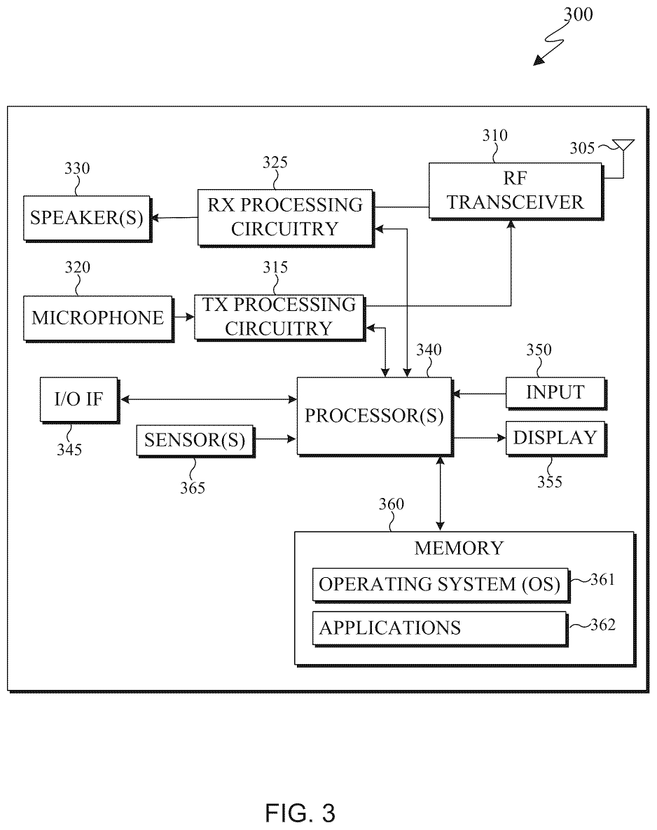

FIGS. 2 and 3 illustrate example electronic devices according to embodiments of the present disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue [RGB] sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

In various embodiments of the present disclosure, a communication system such as communications system 100 may include one or more of an Application Function (AF), Access and Mobility Function (AMF), Policy Control Function (PCF), Session Management Function (SMF), and a User Plane Function (UPF). As described herein, an AF, AMF, PCF, SMF, and a UPF can be implemented in various ways, including as hardware, software, or a combination of both. In a hardware-based implementation, the above functions may include one or more processors, communication interfaces, and memory elements. The communication interfaces may include wired or wireless interfaces to facilitate data exchange with other network elements. Alternatively, the above functions can be implemented as software modules. In a software-based implementation, the above functions can comprise program instructions stored in a non-transitory computer-readable medium, such as flash memory, hard disk drives, or solid-state drives. These program instructions, when executed by one or more processors, cause the processors to perform the functions associated with the above functions.

In some embodiments, the above functions may be implemented using a combination of hardware and software. For example, certain functions may be executed by hardware components to achieve high performance, while other functions may be performed by software modules to provide flexibility and ease of updates.

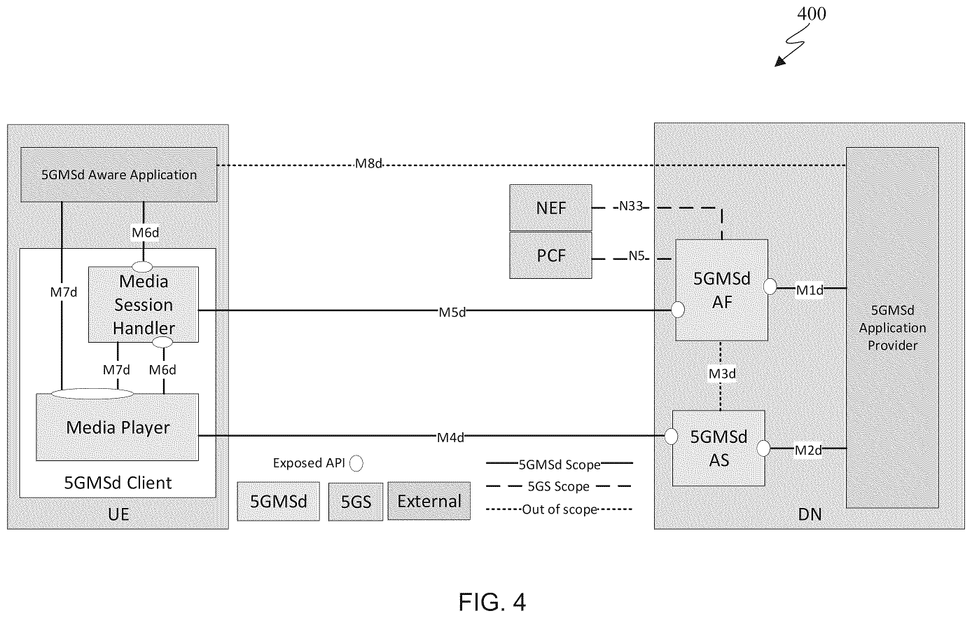

In various embodiments of the present disclosure, a communication system such as communications system 100 may be used to perform 5G Media Streaming (5GMS) based on the 5GMS architecture shown in FIG. 4.

FIG. 4 illustrates an example 5GMS architecture 400 according to embodiments of the present disclosure. The embodiment of a 5GMS architecture of FIG. 4 is for illustration only. Different embodiments of a 5GMS architecture could be used without departing from the scope of this disclosure.

In some embodiments, 5GMS architecture 400 may include one or more of the following components (some of which are not shown in FIG. 4):
5GMS AF: An Application Function dedicated to 5G Media Streaming. In the present disclosure, a 5GMS AF may also be referred to simply as an Application Function or AF. Any other generic Application Function may also be referred to herein as AF.
5GMS AS: An Application Server (AS) dedicated to 5G Media Streaming. In the present disclosure, a 5GMS AS may also be referred to simply as an Application Server or AS.
5GMS Client: A UE internal function dedicated to 5G Media Streaming. The 5GMS Client is a logical function and its sub-functions may be distributed within the UE according to implementation choice.
Media Stream Handler: A UE internal function that is part of the 5GMS Client and responsible for media stream handling functionality.
3GPP Access Node: An access network node in a 3GPP RAN (e.g., 4G LTE, 5G, NR, etc. base station such as base station 118).
Non-3GPP Access Node: An access network node that enables connectivity to a Non-3GPP access endpoint (such as wireless access point 120) to a 3GPP network (e.g., via a Non-3GPP Interworking Function [N3IWF] of a 3GPP network).
5GMS Application Provider: A service provider providing 5G media streaming services.
SMF: A Session Management Function in a 3GPP network.
UPF: A User Plane Function in 3GPP network.
5GMS ASP: An Application Service Provider (ASP) that provides 5G Media Streaming services to subscribed users using a 5GMS system. In the present disclosure, a 5GMS ASP may also be referred to simply as an Application Service Provider or ASP.

By utilizing 5GMS architecture 400, media services can be provisioned by an application service provider at a 5G AF using the M1 interface and content is ingested to a 5G AS using the M2 interface. After any processing to the ingested media (as provisioned by the application service provider and enforced by the 5G AF), the content is then distributed to end users using the M4 interface. The end user device UE uses the M5 and M4 interfaces to communicate back with the control and user plane functions (i.e., the 5G AF and 5G AS) in the core network.

Although FIG. 4 illustrates an example 5GMS architecture 400, various changes may be made to FIG. 4. For example, architecture 400 could include additional core network functions, etc. according to particular needs.

Many technological advancements are being developed as part of the standardization of 5G cellular networks. One of the important enablers of next generation technology for wireless networks that is being currently developed is network slicing. Using network slicing, operators may setup multiple logical networks on the same physical network operator infrastructure to provide differentiated capabilities to end users and service providers. In addition to network slicing, multi-access delivery features are being developed wherein a UE may use multiple connection endpoints (e.g., Wi-Fi, 4G LTE, 5G NR, satellite access endpoints, etc.) to communicate with operator network functions to help with service delivery to the end user. Gateway devices are standardized that sit at the edge of operator core networks to provide connection from multiple access network nodes to network functions inside the operator network. These newer technologies that are being developed have to interoperate with each other for successful deployment of next generation 5G services.

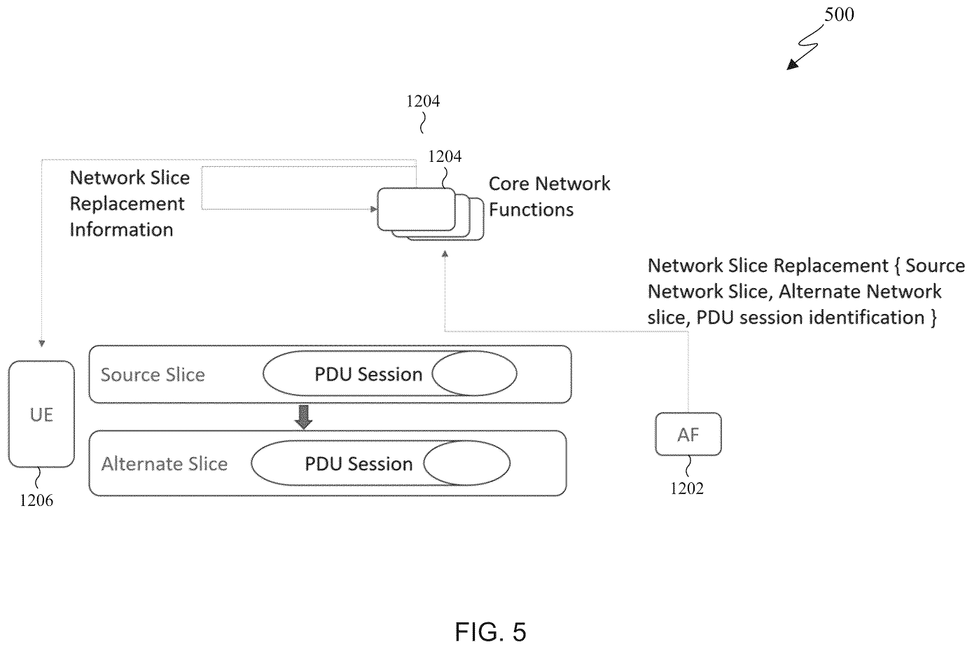

3GPP technical standard (TS) 23.501, TS 23.502, and TS 23.503 describe system features and procedures for network slicing. One of the aspects described in these specifications is the aspect of network slice replacement in which a PDU session delivered in a specific network slice, because of performance or maintenance reasons, gets migrated to an alternate network slice for a period of time. Operator network functions in the core network such as the PCF, NSSF, and/or the OAM take the decision for such a network slice replacement procedure. After a certain time, upon the network operator's decision, the PDU session gets moved back from the alternate network slice to the original network slice. The above specifications also define an AF-influenced network slice replacement in which the operator network function (e.g., the Application Function-AF) initiates the network slice replacement procedure similar as shown in FIG. 5.

FIG. 5 illustrates an example Application Function influenced network slice replacement 500 according to embodiments of the present disclosure. The embodiment of a network slice replacement of FIG. 5 is for illustration only. Different embodiments of an Application Function influenced network slice replacement could be used without departing from the scope of this disclosure.

In the example of FIG. 5, an Application Function in the core network of a 5G network operator, may inform other core network functions 504 (such as a PCF, SMF, NSSF etc.) that a PDU Session is to be migrated from a source network slice to an alternate network slice. The AF 502 may provide the information such as the source network slice, alternate network slice, and the PDU session identification information to the other core network functions 504 to enable such a network slice replacement procedure. When the other core network functions receive such information from the AF 502, they may initiate the process of slice replacement during which they inform any other core network functions 504 and UE 506 of network slice replacement information. One such information that may be delivered by one or more of the core network functions 504 is updated network slice rules (e.g., user equipment route selection policy [URSP] rules) (e.g., similar as described in 3GPP TS 23.501, TS 23.502, and TS 23.503).

Although FIG. 5 illustrates one example Application Function influenced network slice replacement 500, various changes may be made to FIG. 5. For example, various changes to the network slice replacement could be influenced by a different network function, etc., according to particular needs.

Within a 5G operator network, there can be subscription policies that are assigned to a UE based on the type of subscription the user of the UE registers for. With 5G, one of the subscription options that the users of the UEs are able to register for is network slicing. With this subscription option, UEs now have access to different types of network slices which the UE uses to receive PDU sessions of differentiated services.

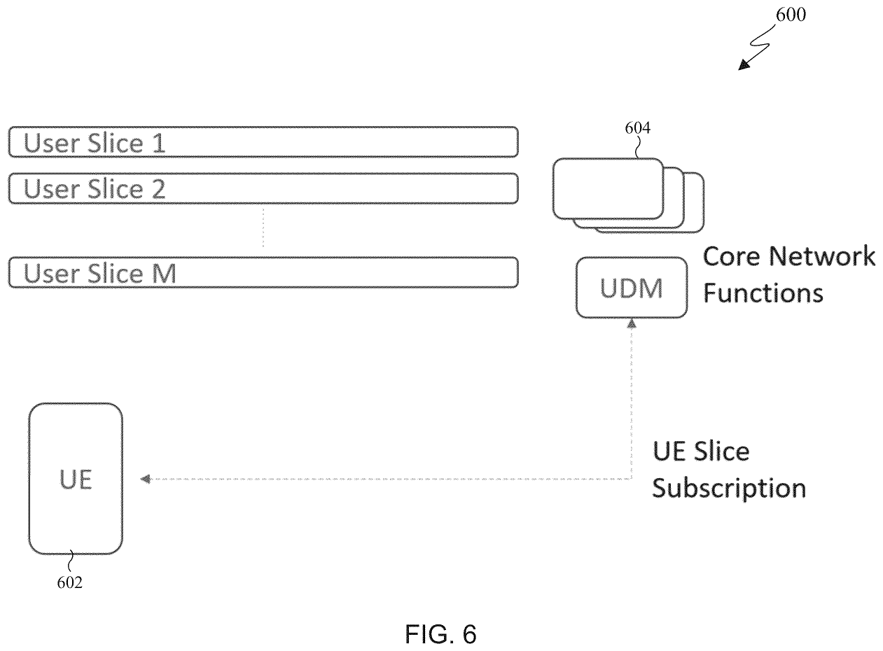

FIG. 6 illustrates an example UE subscription of network slices 600 according to embodiments of the present disclosure. The embodiment of UE subscription of network slices of FIG. 6 is for illustration only. Different embodiments of UE subscription of network slices could be used without departing from the scope of this disclosure.

In the example of FIG. 6, UE 602 may have subscription to multiple network slices. Based on a user subscription, the operator network functions 604 prepare appropriate URSP rules to allow for transmitting and receiving PDU session traffic over different network slices between the UE 602 and the operator network. Furthermore, in an AF influenced network slice replacement, similar as described regarding FIG. 5, upon user subscription, the PDU Session traffic in one of the subscribed network slices may be migrated by an AF to another subscribed network slice as part of a network slice replacement procedure.

Although FIG. 6 illustrates one example UE subscription of network slices 600, various changes may be made to FIG. 6. For example, various changes to the number of slices could be made, etc., according to particular needs.

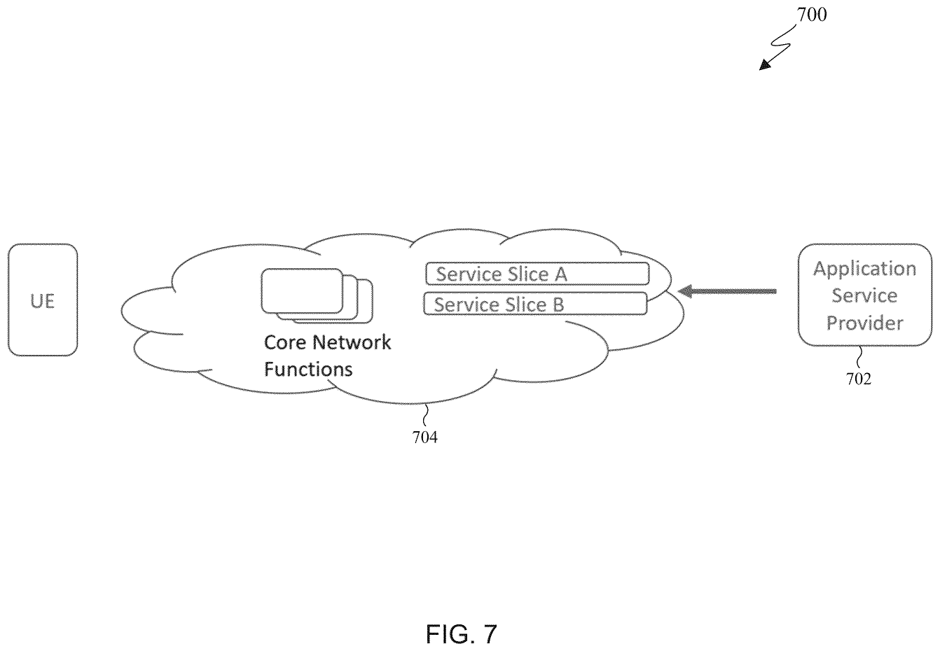

In some embodiments, an application service provider may use network slice templates (NESTs), similar as those standardized by the Global System for Mobile communications (GSM) Association (GSMA) standards organization, to configure network slicing for different services in the operator network similar as shown in FIG. 7.

FIG. 7 illustrates an example of network slice configuration of service parameters 700 according to embodiments of the present disclosure. The embodiment of network slice configuration of service parameters of FIG. 7 is for illustration only. Different embodiments of network slice configuration of service parameters could be used without departing from the scope of this disclosure.

In the example of FIG. 7, an Application Service Provider 702 may configure one or more network slices (two in the example of FIG. 7, but any number of network slices may be configured). The service configuration could be performed, for example using the M1 Provisioning API specified in 3GPP TS 26.501 and TS 26512. Among a number of service configuration parameters an application service provider may be able to configure, the parameters for network slicing are significant because they provide the ability for the application provider to convey different requirements for delivery of the service such as quality of service (QoS), quality of experience (QoE), etc. In addition, the application provider 702, based on monitoring of service delivery information received from the operator network 704, can have the ability to re-configure the network slice parameters to cope up with changing demands of the service using a specific network slice.

As shown in FIG. 7, the application service provider 702 may configure one or more network slices in which a service may be delivered by the network operator.

Although FIG. 7 illustrates one example of network slice configuration of service parameters 700, various changes may be made to FIG. 7. For example, various changes to the number of slices could be made, etc., according to particular needs.

As described above regarding FIG. 6 and FIG. 7, user slices can be based on user subscription while service provisioning can perform to configure a service for distribution to end users. These two types of slices-user slices and service slices may be the same if the network operator exposed user slice information to external parties. However, it is highly possible that the network operator would not expose such user subscription information to external 3^{rd} parties. As a result, any network slice replacement procedure, for example as specified in 3GPP TS 23.501, TS 23.502, and TS 23.503, needs awareness of the relationship between the user slices and service slices because the network slice replacement procedure primarily uses the user slice information.

To address this problem, various embodiments of the present disclosure provide a mapping procedure to help map the external service slices to internal user slice information.

Multi-access (MA) is specified in the 3rd Generation Partnership Project (3GPP) technical standard (TS) 23.501 as an optional feature, Access Traffic Steering, Switching, Splitting) (ATSSS), in the 5G System. Some of the key principles defined by 3GPP TS 23.501 are:
a) The ATSSS feature enables a Multi-Access PDU Connectivity Service allowing for the exchange of PDUs between the UE and a Data Network by simultaneously using one 3GPP access network and one non-3GPP access network via two independent N3/N9 tunnels between a PDU Session Anchor UPF and the RAN/AN.
b) The Multi-Access PDU Connectivity Service is facilitated by a Multi-Access PDU (MA PDU) Session that may have User Plane resources on two access networks. In the context of the generalised media delivery architecture:
   If conveyed over an MA PDU Session the application flow between the Media Session Handler and the Media AF at reference point M5 may use two different access networks.
   If conveyed over an MA PDU Session, the application flow between the Media Access Client and the Media AS at reference point M4 may use two different access networks.
c) The UE is supplied with policy rules (“ATSSS rules”) by the network for deciding how to distribute uplink traffic across multiple access networks. Similarly, the UPF anchor is supplied with policy rules (“N4 rules”) by the network for deciding how to distribute downlink traffic across the two N3/N9 tunnels and the two access networks. The network entity configuring ATSSS rules and N4 rules is the SMF. The SMF may map PCC rules from the PCF to create these ATSSS and N4 rules.
d) The UE indicates its support for ATSSS (steering functionalities and steering modes) in the PDU Session Establishment Request that is sent to request a new MA PDU Session.
e) If the UE requests a single network slice selection assistance information (S-NSSAI), the same S-NSSAI is allowed on both the access networks.
f) For QoS support, the same 5G QoS model used for conventional PDU Sessions also applies to MA PDU Sessions, (i.e. QoS Flow is the finest granularity of QoS differentiation). However, QoS Flow is access-agnostic: the same network QoS applies to each of the different access network comprising the MA PDU Session, i.e. the same QoS is available across two different paths in different access networks. The network (SMF) may provide QoS rules to the UE via one access network that are used for both the 3GPP access network and non-3GPP access network.
   In the context of the generalised media delivery architecture, application flows at reference point M5 and/or M4 using a MA PDU Session may have similar network QoS as when they are transmitted via the 3GPP access network alone.
g) The network may provide Measurement Assistance Information to the UE and/or UPF to assist them in determining which measurements (round trip measurements, packet loss rate measurements) are to be performed before deciding how to distribute traffic across two access networks.
h) The ATSSS rules provided to the UE by the network contain information about the type of steering functionality to be used to distribute traffic across multiple access networks. Steering functionality is the functionality that can steer, switch, and split traffic across multiple access networks, supported steering functionalities include (e.g., from clause 5.32.8 of 3GPP TS 23.501):
   Higher-layer MPTCP (Multipath TCP) functionality—The UPF provides MPTCP proxy functionality. Corresponding MPTCP functionality in the UE may communicate with the MPTCP proxy in the UPF to distribute and aggregate traffic across multiple access networks.
   Higher-layer MPQUIC (Multipath-enabled QUIC) functionality—The UPF provides MPQUIC proxy functionality. The corresponding MPQUIC functionality in the UE may communicate with the MPQUIC proxy in the UPF to distribute and aggregate traffic across multiple access networks.
   ATSSS Low-Layer (ATSSS-LL) functionality—Functionality that allows steering, switching, and splitting of traffic across two access networks based on information from IP layer and below.
i) The ATSSS rules provided to the UE by the network indicates which steering mode is to be applied to matching traffic for each Service Data Flow (SDF). The steering mode determines how the matching traffic is to be distributed across 3GPP and non-3GPP access networks. Supported steering modes in Release 18 include:
   Active-Standby: Used to steer matching SDF packets onto one access network (the “Active access”) when this is available, and onto another (the “Standby access”) when the Active access is unavailable.
   Smallest Delay: Matching SDF packets are steered to the access network with smallest packet round-trip time.
   Load-Balancing: Used to split the delivery of SDF packets between both the access networks if both of them are available.
   Priority-based: Used to steer SDF packets onto an access network with a higher priority.
   Redundant: Used to duplicate SDF packets on both access networks if both of them are available.

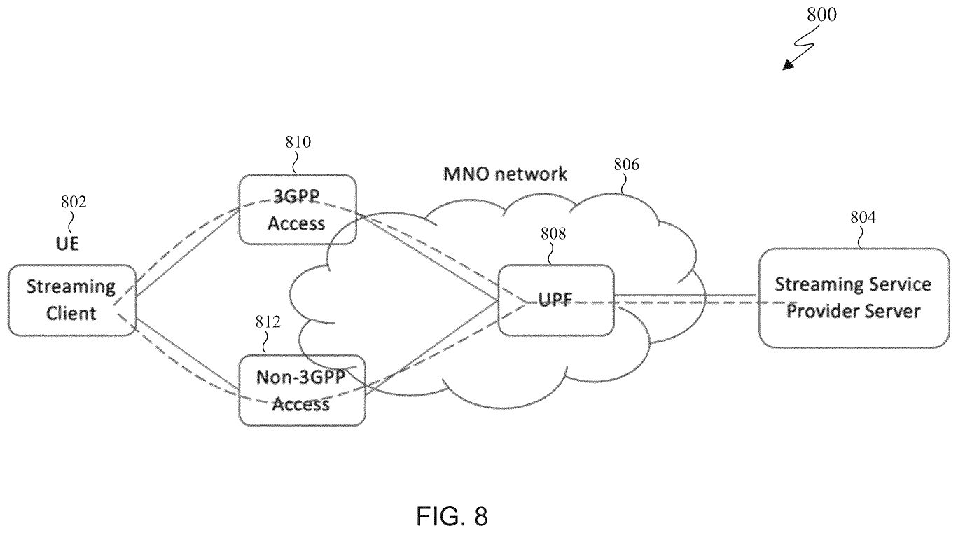

FIG. 8 illustrates an example of multi-access delivery 800 according to embodiments of the present disclosure. The embodiment of multi-access delivery of FIG. 8 is for illustration only. Different embodiments of a multi-access delivery could be used without departing from the scope of this disclosure.

In the example of FIG. 8 a UE 802 is operating a streaming client, which is streaming traffic (for example, video frames), from a streaming service provider server 804 over a mobile network operator (MNO) network 806. The traffic is routed by a UPF 808 over a 3GPP access 810 and a non-3GPP access 812 to UE 802.

Although FIG. 8 illustrates an example of multi-access delivery 500, various changes may be made to FIG. 8. For example, the multi-access delivery 500 could include additional access networks, etc. according to particular needs.

3GPP technical report (TR) 26.941 clause 4.2.2 describes a network slice replacement procedure when a network slice becomes unavailable. 3GPP TS 23.501 clause 5.15.19 describes this procedure further in detail. As part of the procedure, an AMF is triggered, either by local configuration, or due to a notification from an operator operations, administration, and maintenance (OAM), network slice selection function (NSSF), or policy control function (PCF), to replace the current S-NSSAI with an alternative S-NSSAI. The notifications from the OAM, NSSF, or PCF to the AMF may include the alternative S-NSSAI information.

When next generation technology enablers such as network slicing and multi-access delivery are used to deliver services to end users, these enablers have to interoperate with each other to provide a seamless service experience to the end users. However, as with many technological enablers, network slicing and multi-access delivery come with their own set of issues and challenges. One of the issues with network slicing is that the network slices are a logical concept on top of a physical network infrastructure. With physical infrastructure, there are always problems with machine downtime, network downtime, compute downtime etc. As a result, network slices that originally provided certain quality and reliability guarantees may not able to provide such guarantees during downtime. In addition, from time to time, the network operator may bring down network slices for maintenance. In such cases when a network slice is unable to provide required efficiency, the network operator may choose to replace the network slice with a new network slice. Various embodiments of the present disclosure provide procedures for network slice replacement when both network slicing and multi-access delivery enablers are used with application sessions.

As noted above, one of the key technologies of 5G network is network slicing. With network slicing, service providers and network operators are able to provide differentiated services and network isolation to subscribed users, wherever and whenever necessary. Service providers possess the ability to request one or more network slices from the OAM. As part of this request, service providers provide service requirements (e.g., in terms of parameters such as required bandwidth, throughput, latency, packet loss, jitter etc.) to the operator OAM. Based on this request, the operator OAM provisions one or more network slices, and returns information about the provisioned network slices back to the service provider. The service provider is then able to use the provisioned network slice during service provisioning tasks. Once the service is provisioned, application traffic related to the provisioned service is transmitted/received over the provisioned network slice.

In some embodiments, an application service provider may use the network slice provisioned by operator OAM to run the application service in the operator network. The network operator may also perform diagnostic services to the provisioned network slices. As part of this, the operator network may use methods to detect the availability and performance of network slices from time to time. Such diagnostics information may be shared with the application service provider. The network operator, may also, from time to time, observe the need to replace the currently provisioned network slices with alternate network slices. Such slice replacement tasks may be undertaken for a number of reasons. For example, the current network slice may be de-provisioned for maintenance reasons, or there may be too much congestion in the network slice, or there may be an observation of negative impact on application performance.

As described earlier herein, a multi-access session between a UE and a network operator can be setup using a Multi-Access PDU Session (referred to hereinafter as an MA PDU Session). A network slice that carries an MA PDU Session may also be replaced using a network slice replacement procedure if the network slice is to be taken down for any reason such as maintenance, insufficient QoS guarantees, or for security purposes.

In some embodiments, To facilitate network slice replacement of a network slice that is carrying an MA PDU Session, an initial registration response may be sent by the network indicating to the UE that in a future event where a network slice replacement procedure is undertaken, a given “Alternate S-NSSAI” is to be used between the UE and the network.

Optionally, in some embodiments, the network slice replacement procedure may also be performed during an ongoing session, based on notification from network functions such as an OAM, NSSF, PCF etc. to the AMF. In this case, a configuration update message (for example, similar as described in 3GPP TS 23.501) can used to send the “Alternate S-NSSAI” to be used post the network slice procedure.

In embodiments such as these, the UE can use the “Alternate S-NSSAI” to switch to when informed by the network. In some embodiments, this information from the network to the UE can be accompanied with updated URSP information that has updated network slice selection rules (for example, similar as described in 3GPP TS 23.501 and 3GPP TS 23.502).

As noted above, various embodiments of the present disclosure provide procedures for network slice replacement when both network slicing and multi-access delivery enablers are used with application sessions.

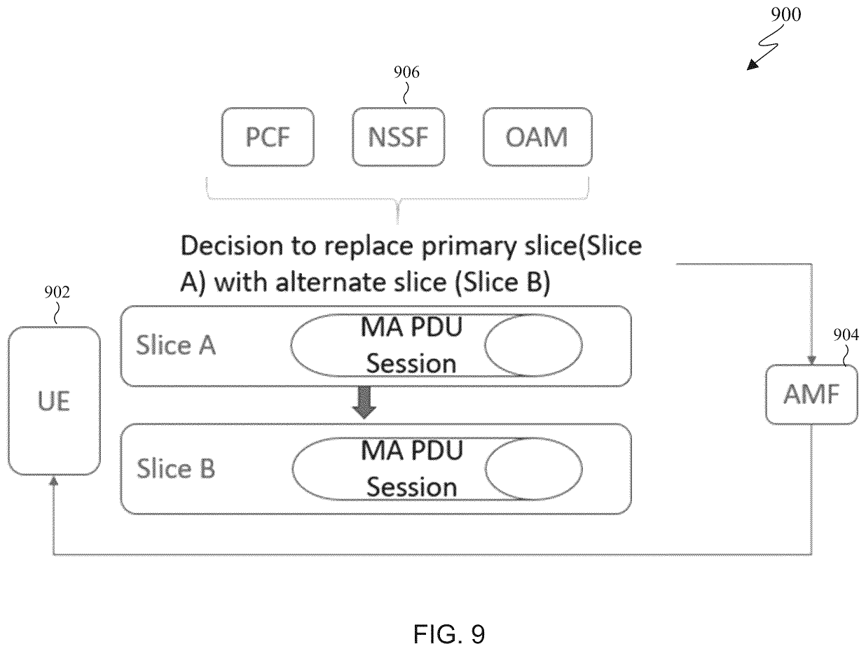

FIG. 9 illustrates an example network slice replacement for a network slice carrying an MA PDU Session 900 according to embodiments of the present disclosure. The embodiment of a network slice replacement of FIG. 9 is for illustration only. Different embodiments of a network slice replacement could be used without departing from the scope of this disclosure.

In the example of FIG. 9, a UE 902 has established an MA PDU Session on a network slice “Slice A”. For one or the reasons described herein, AMF 904 is triggered, either by local configuration, or due to a notification from network functions 906 to replace Slice A with an alternate network slice “Slice B”.

Although FIG. 9 illustrates one example network slice replacement for a network slice carrying an MA PDU Session 900, various changes may be made to FIG. 9. For example, various changes to the network functions could be made, etc. according to particular needs.

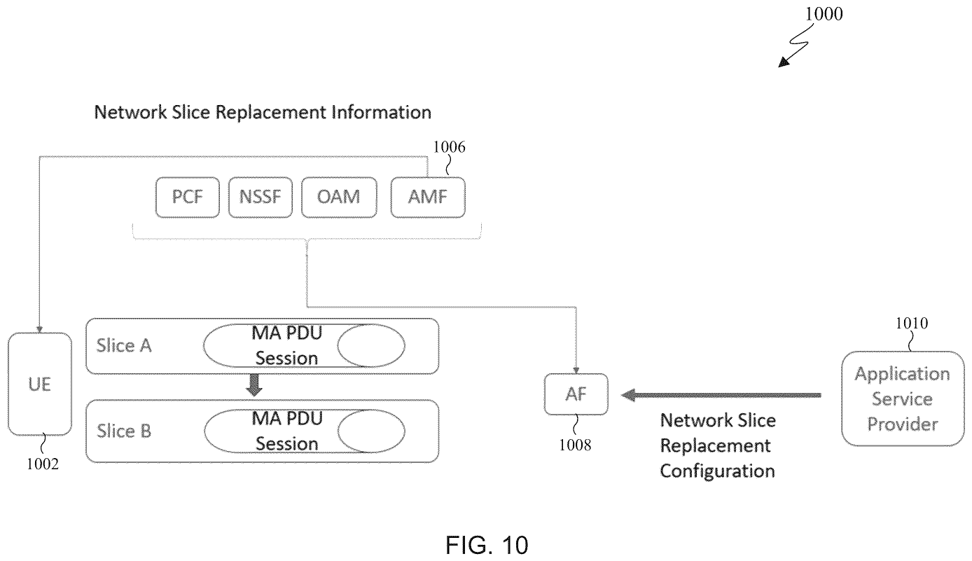

FIG. 10 illustrates an example procedure for network slice replacement with a network slice carrying an MA PDU Session 1000 according to embodiments of the present disclosure. The embodiment of a procedure for network slice replacement of FIG. 10 is for illustration only. Different embodiments of a procedure for network slice replacement could be used without departing from the scope of this disclosure.

In the example of FIG. 10 a UE 1002 has established an MA PDU Session on a network slice “Slice A”. For one or the reasons described herein, a network function 1006 (such as an AMF) is triggered, either by local configuration, or due to a notification from another network function 1006 to replace Slice A with an alternate network slice “Slice B”. As part of this procedure, a 3rd party entity, for example the Application Provider or Application Service Provider 1010 (similarly described in 3GPP TS 26.501) may configure a network slice replacement configuration information in the network. In the example of FIG. 10, this information is configured at an Application Function (AF) 1008 in the network. Other options of an Application Provider configuring this information at the other network functions 1006 (e.g., a PCF, NEF etc.) are equally applicable (for example, similar as described in 3GPP TS 23.501 and 3GPP TS 23.502).

As part of the network slice replacement configuration information, the Application provider may provide the configuration information shown in Table 1 to the network.

TABLE 1
Network Slice Replacement Configuration Information

| Configuration | |
|---|---|
| Information | Description |
| Slice Replacement type | Describes the type of network slice replacement to be undertaken. |
| | Possible values include the following: |
| | No replacement: Do not perform network slice |
| | replacement if this option is provided as the configuration |
| | for slice replacement type. |
| | In this case, if the conditions for network slice replacement occur, |
| | the network is to continue using the same network slice, and not |
| | perform any network slice replacement tasks. |
| | Preferred Alternate network slice S-NSSAI: Information |
| | about the preferred Alternate S-NSSAI if the MA PDU |
| | Session in the current primary network slice is to be |
| | relocated to a different slice because of a network slice |
| | replacement procedure. |
| | If this option is provided by the Application Service Provider, the |
| | following additional information may also be included in the |
| | configuration information: |
| | Replacement time: Amount of time the primary |
| | slice is to be replaced by the given Alternate S- |
| | NSSAI |
| | Rollback method: Method to roll back if a |
| | notification is not received within the Replacement |
| | time about going back to the original primary |
| | network slice. Possible values of this information |
| | element include the following: |
| | Automatic: Signifies automatic rollback to |
| | the original primary network slice at the |
| | expiry of Replacement time if no |
| | notification is received whether to continue |
| | in the Alternate S-NSSAI or switch to the |
| | original network slice or possibly to a |
| | totally new network slice. |
| | Rollback after time interval: If this option is |
| | provided, an automatic rollback to the |
| | original primary slice from the current |
| | Alternate S-NSSAI is performed after |
| | waiting for this time interval post the expiry |
| | of the Replacement time and when no |
| | notification for explicit switch to any other |
| | network S-NSSAI is received. |
| | Replacement with multiple-slice-setup: If this option is |
| | provided by the Application Service Provider, the |
| | procedure to switch to a multi-slice setup is requested. The |
| | details of this procedure are described later herein. All |
| | accompanying information described in that procedure |
| | may be provided by the Application Service Provider as |
| | part of the network slice replacement configuration |
| | information. |

Although FIG. 10 illustrates one example procedure for network slice replacement with a network slice carrying an MA PDU Session 1000, various changes may be made to FIG. 10. For example, various changes to the network functions could be made, etc. according to particular needs.

As noted above in Table 1, in some embodiments a slice replacement type may be indicated as “Replacement with multiple-slice-setup.”

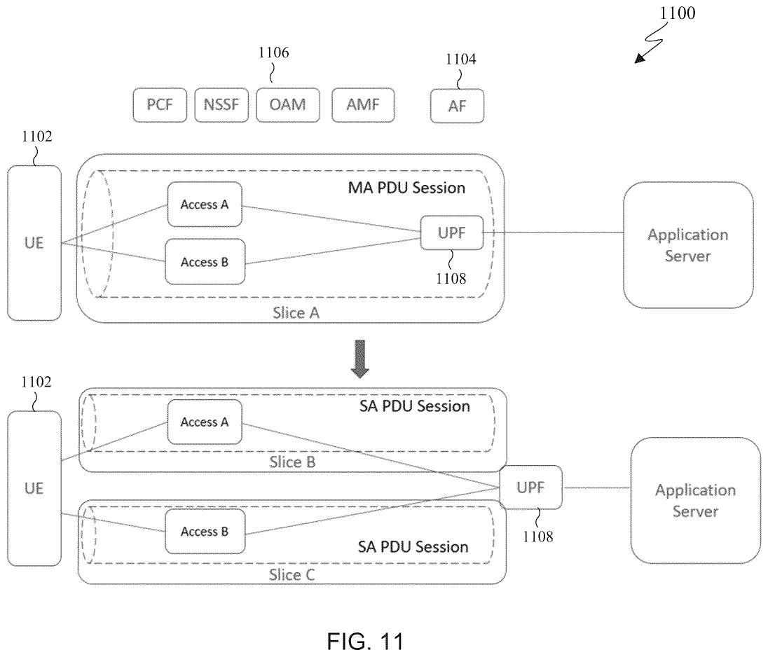

FIG. 11 illustrates an example procedure for network slice replacement with multi-slice setup 1100 according to embodiments of the present disclosure. The embodiment of a procedure for network slice replacement of FIG. 11 is for illustration only. Different embodiments of a procedure for network slice replacement could be used without departing from the scope of this disclosure.

In the example of FIG. 11, a UE 1102 has established an MA PDU Session on a network slice “Slice A” spanning two access networks (“Access A” and “Access B”). For one of the reasons described herein (e.g., a condition as described in 3GPP TS 23.501), a network function 1106 (such as an AMF) is triggered, either by local configuration, or due to a notification from another network function 1106 to replace Slice A with multiple network slices “Slice B” and “Slice C” such that Slice B and Slice C each carry a Single Access PDU Session (SA PDU Session). Due to network slice replacement scenario of FIG. 8, Slice B and Slice C each carry a part of the multi-access delivery traffic, with each network slice spanning one or more of the access networks in the original MA PDU Session. To facilitate this procedure, the network operator may update the URSP rules with new network slicing information and send them to the UE 1102. The network operator then informs the network functions 1106 (e.g., AMF, SMF, UPF) of the change of PDU Sessions from a MA PDU Session to a Single Access PDU Session. The network operator may provision a UPF 1108 with attachment points to multiple network slices as shown in FIG. 11.

In some embodiments, to facilitate switching to multiple network slices from a single network slice, a network operator function such as AMF 1104, based on notification from other network functions 1106 (NSSF, OAM, PCF etc.), may initiate this switching process from a single network slice to multiple network slices in the destination slice set. During this switching procedure, the following actions are performed:
Each network slice in the to-be-replaced-with multiple network slices is configured to have one of the following options by the network operator function:
   The SLA parameters of each of the to-be-replaced-with network slice in the destination slice set is set to at least be equal to the SLA parameters of the original primary network slice that was carrying the MA PDU Session traffic (i.e., each of the network slices in the to-be-replaced-with slice destination set inherit properties from its parent original primary network slice). To facilitate this, the network operator function that is taking the responsibility of network slice replacement requests the instantiation of multiple network slices based on the SLA parameter configuration of the original primary network slice.
   Each of the SLA parameters of each of the to-be-replaced-with multiple network slices are at an “offset” from the corresponding SLA parameter of the original primary network slice.
   Optionally, the network operator function may configure the SLA parameters for each network slice in the set of to-be-replaced-with multiple network slices independent of each other based on the configuration of SLA parameters of the original primary network slice.
The network operator may configure the UPF 1108 to receive content from all the network slices. Optionally, the network operator may provision a new UPF to receive the content from all network slices.
   In some embodiments, to facilitate the configuration of multiple network slices when a single network slice carrying MA PDU Session is replaced with multiple network slices of SA PDU Session, one of the following may be carried out:
The application service provider may provide the detailed configuration as described herein for each of the to-be-replaced-with multiple network slices based on the SLA configuration of original primary network slice.
The OAM may provide (or update) the detailed configuration as described herein for each of the to-be-replaced-with multiple network slices based on the SLA configuration of original primary network slice.
One of the network functions 1106 such as the PCF, NSSF may configure the SLA parameters for each of the to-be-replaced-with multiple network slices based on the SLA configuration of original primary network slice.

Although FIG. 11 illustrates one example procedure for network slice replacement with multi-slice setup 1100, various changes may be made to FIG. 11. For example, various changes to the network functions could be made, etc. according to particular needs.

In some embodiments, such as described herein regarding FIG. 11, a network slice carrying an MA PDU Session, is replaced with multiple network slices when the conditions for such a replacement are observed. Alternatively, in some embodiments, a network operator may pre-provision the network and/or a UE with a configuration information of all to-be-replaced-with network slices in case the current network slice has to be replaced with an alternate network slice. In some embodiments, this procedure may also be applied to an SA PDU Session in addition to an MA PDU Session.

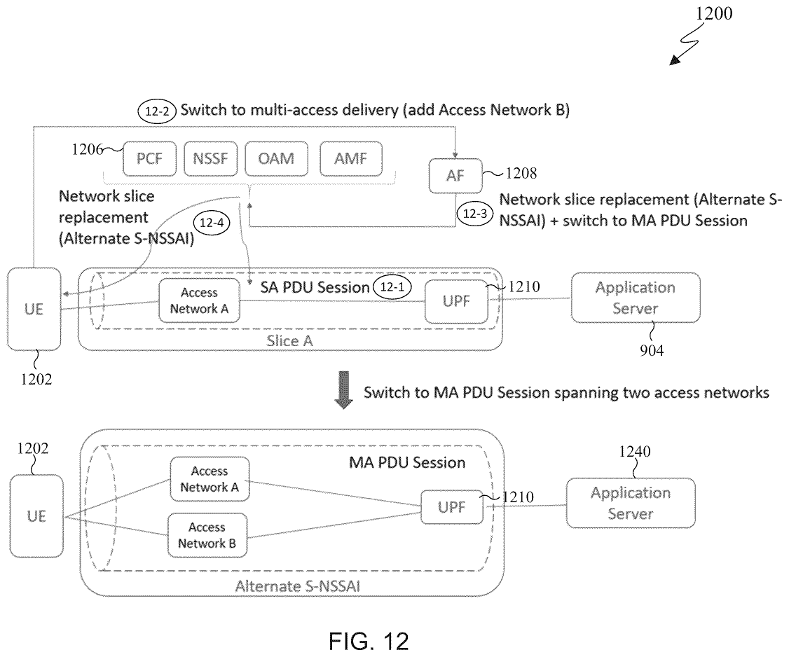

In some embodiments, a UE may request to switch to multi-access delivery from single-access delivery. In embodiments such as these, a procedure such as the procedure illustrated in FIG. 12 can enable switching to a Multi-Access session spanning multiple access networks during a network slice replacement procedure.

FIG. 12 illustrates an example procedure to switch to an MA PDU Session upon request to enable multi-access delivery 1200 according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a procedure to switch to an MA PDU Session upon request to enable multi-access delivery could be used without departing from the scope of this disclosure.

In the example of FIG. 12, the procedure 1200 begins at step 12-1. At step 12-1, a delivery session using a single access network is ongoing between a UE 1202 and an application server 1204 through network operator functions 1206. The session is using a SA PDU Session for transmitting and receiving application content between the UE 1202 and the application server 1204.

At step 12-2, the UE 1202 (or an application on the UE 1202) requests adding an additional access network to the media streaming session so the UE 1202 can avail the benefits of using multiple access endpoints to increase the available throughput and bandwidth for the application session. The request may include information about the additional access network to be added to the application session. This request is sent to a network apparatus entity in the network (e.g., the AF 1208) (for example, similarly as specified in 3GPP TS 26.501). In some embodiments, the M5 API specified in 3GPP TS 26.501 may be enhanced to carry this request from the UE 1202 to the AF 1208.

At step 12-3, the AF 1208 receives the request from the UE 1202, infers that the UE 1202 intends to use multiple access networks, determines that the request to add a new access network in the current network slice is not possible, and deduces that the current network slice is to be replaced with a new network slice. The AF 1208 then derives the alternate slice information (Alternate S-NSSAI) to which the application session is to be switched so it can carry content from UE 1202 via both the access networks. The AF 1208 then sends a request to network operator functions 1206 (e.g., PCF, AMF, SMF, NSSF etc.) to perform the network slice replacement procedure, and in the process switches the current SA PDU Session to an MA PDU Session spanning multiple access networks.

At step 12-4, the network operator functions 1206 receive the request from the AF 1208, and initiate the network slice replacement procedure (for example, similar as described in 3GPP TS 23.501) to migrate the application media streams to an alternate network slice (Alternate S-NSSAI). The network functions 1206 also inform the UE 1202 of updated URSP rules providing new network slice information. The network functions also provision multi-access transmit and reception features in the UPF 1210 to enable transmitting and receiving of content via multiple access network nodes.

Although FIG. 12 illustrates one example procedure to switch to an MA PDU Session upon request to enable multi-access delivery 1200, various changes may be made to FIG. 12. For example, while shown as a series of steps, various steps in FIG. 12 could overlap, occur in parallel, occur in a different order, occur any number of times, be omitted, or replaced by other steps.

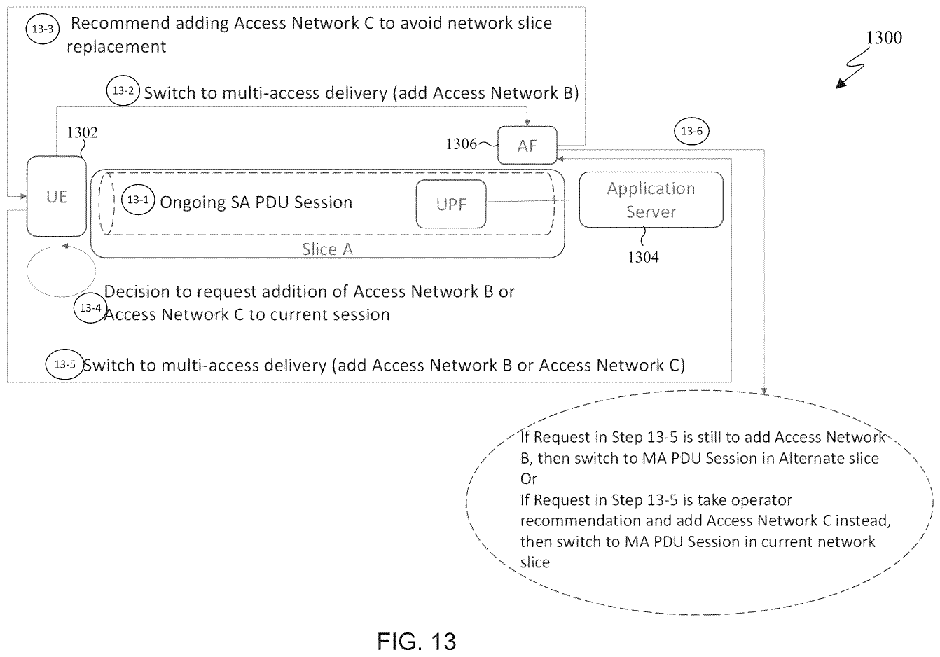

In some embodiments, the network may provide a recommendation/suggestion to add a different access network than an access network requested by a UE, so the network need not initiate replace the current network slice with an Alternate network slice. In embodiments such as these, a procedure such as the procedure illustrated in FIG. 13 can enable switching to a Multi-Access session spanning multiple access networks during a network slice replacement procedure.

FIG. 13 illustrates an example procedure for network recommendation to stay in or switch a current network slice to enable multi-access delivery 1300 according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a procedure for network recommendation to stay in or switch a current network slice to enable multi-access delivery could be used without departing from the scope of this disclosure.

In the example of FIG. 13, the procedure 1300 begins at step 13-1. At step 13-1, An application session between a UE 1302 and an application server 1304 is ongoing via a SA PDU Session.

At step 13-2, UE 1302 (or an application on the UE 1302) requests switching to multi-access delivery and provides the new access network information (Access Network B) to add to the current application session.

At step 13-3, the AF 1306 and/or the network functions infer that in order to add Access Network B to current application session, the application session is to be carried by a MA PDU Session instead of the current SA PDU Session, and that the current network slice (Slice A) is to be replaced with an alternate network slice as the current slice is not capable of carrying MA PDU Session spanning multiple access networks. Based on this inference, AF 1306 and/or operator network functions, send a response to UE 1302 to enable multi-access delivery over a different access network (Access Network C) instead. This inference is based on available access network performance information at the network.

At step 13-4, the UE 1302 decides whether to continue request adding its preferred access network (Access Network B) or take the recommendation from the network to add another access network (Access Network C).

At step 13-5, the UE 1302 sends an updated request to the AF 1306, and/or network functions, to switch to multi-access delivery based on its decision in Step 13-4.

At step 13-6, if the UE 1302 stays with its decision to add Access Network B to the current application session, then the AF 1306, and/or the network functions, switch the current SA PDU Session to a MA PDU Session over an alternate network slice similar as described herein (for example, with respect to FIG. 12). Alternatively, if the UE decides to take the recommendation, and requests adding multi-access delivery over the recommended/suggested access network (Access Network C), then the AF 1306, and/or network functions in the operator network, migrate the SA PDU Session to a MA PDU Session, but stay in the current network slice.

Although FIG. 13 illustrates one example procedure for network recommendation to stay in or switch a current network slice to enable multi-access delivery 1300, various changes may be made to FIG. 13. For example, while shown as a series of steps, various steps in FIG. 13 could overlap, occur in parallel, occur in a different order, occur any number of times, be omitted, or replaced by other steps.

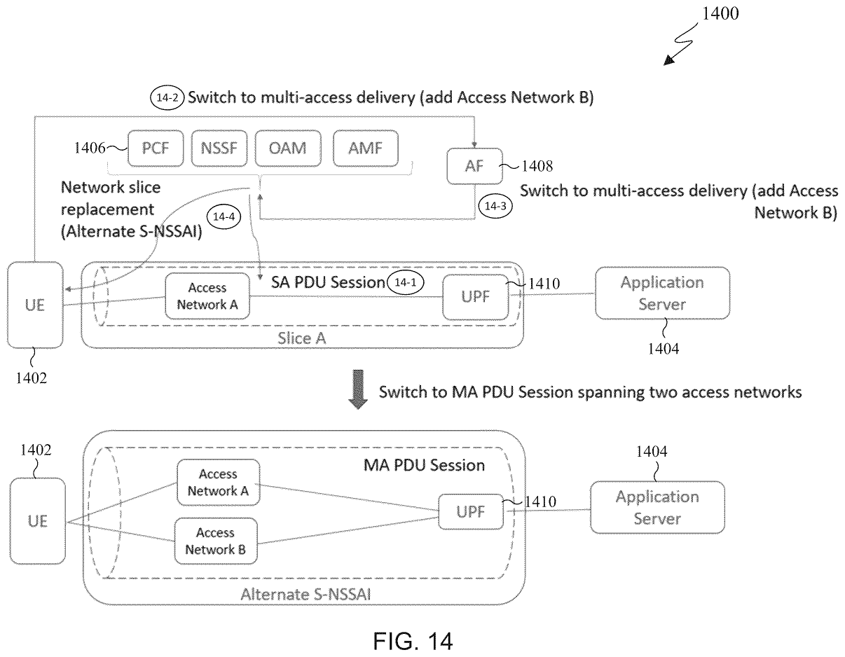

As noted above, in some embodiments, a UE may request to switch to multi-access delivery from single-access delivery. In embodiments such as these, a procedure such as the procedure illustrated in FIG. 14 can enable switching to a Multi-Access session spanning multiple access networks during a network slice replacement procedure.

FIG. 14 illustrates another example procedure to switch to an MA PDU Session upon request to enable multi-access delivery 1400 according to embodiments of the present disclosure. An embodiment of the procedure illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a procedure to switch to an MA PDU Session upon request to enable multi-access delivery could be used without departing from the scope of this disclosure.

In the example of FIG. 14, the procedure 1400 begins at step 14-1. At step 14-1, a delivery session using a single access network is ongoing between a UE 1402 and an application server 1404 through network operator functions 1406. The session is using a SA PDU Session for transmitting and receiving application content between the UE 1402 and the application server 1104.

At step 14-2, the UE 1402 (or an application on the UE 1402) requests adding an additional access network to the media streaming session so the UE 1402 can avail the benefits of using multiple access endpoints to increase the available throughput and bandwidth for the application session. The request may include information about the additional access network to be added to the application session. This request is sent to a network apparatus entity in the network (e.g., the AF 1408) (for example, similarly as specified in 3GPP TS 26.501). In some embodiments, the M5 API specified in 3GPP TS 26.501 may be enhanced to carry this request from the UE 1102 to the AF 1408.

At step 14-3, the AF 1408 receives the request from the UE 1402, infers that the UE 1402 intends to use multiple access networks, and forwards the request to the network operator functions 1406 (e.g., PCF, AMF, SMF, NSSF etc.) to add a new access network path to an existing application session over a single access network.

At step 14-4, the network operator functions 1406 receive the request from the UE, infer that the UE intends to use multiple access networks, determines that the request to add a new access network in the current network slice is not possible, and deduces that the current network slice is to be replaced with a new network slice. The network functions then derive the alternate slice information (Alternate S-NSSAI) to which the application session is to be switched so it can carry content from UE via both the access networks. The network functions also deduce that the current SA PDU Session is to be switched to a MA PDU Session. The network operator functions initiate the network slice replacement procedure (for example, similar as described in 3GPP TS 23.501) to migrate the application media streams to an alternate network slice (Alternate S-NSSAI). The network functions also inform the UE of updated URSP rules providing new network slice information. The network functions also provision multi-access transmit and reception features in UPF 1410 to enable transmitting and receiving of content via multiple access network nodes.

Although FIG. 14 illustrates one example procedure to switch to an MA PDU Session upon request to enable multi-access delivery 1400, various changes may be made to FIG. 14. For example, while shown as a series of steps, various steps in FIG. 14 could overlap, occur in parallel, occur in a different order, occur any number of times, be omitted, or replaced by other steps.

As noted above in some embodiments, the network may provide a recommendation/suggestion to add a different access network than an access network requested by a UE, so the network need not initiate replace the current network slice with an Alternate network slice. In embodiments such as these, a procedure such as the procedure illustrated in FIG. 13 can enable switching to a Multi-Access session spanning multiple access networks during a network slice replacement procedure. In the procedure of FIG. 13, the UE 1302 communicates with the AF 1306, and the AF 1306 infers the need to perform network slice replacement before the AF 1306 provides a recommendation for an alternate Access Network. Alternatively, in some embodiments, the steps to infer the likelihood of switching to an alternate network slice because of adding a new access network path to a current SA PDU Session may be performed by the operator network functions such as the AMF, PCF, SMF, NSSF etc. In this case, when the UE 1302 requests AF 1306 to add an access network connection to existing application session, the AF 1006 forwards the request to the network functions. The network functions then infer the need to migrate to an alternate network slice if the current SA PDU Session is to be converted to an MA PDU Session, and may inform the AF 1306 of the alternate access network recommendation. The AF 1306 then forwards this information to UE 1302 (for example using an M5 interface as specified in 3GPP TS 26.501). The rest of the steps in these embodiments are identical to the steps described regarding FIG. 13.

As noted above, various embodiments of the present disclosure provide a mapping procedure to help map the external service slices to internal user slice information. For example, the mapping could be defined as shown in Table 2 below:

TABLE 2
Mapping between service slices and user slices

| Service Slice | User slices |
|---|---|
| Service Slice A (SS A) | User Slice 1 (US 1), User Slice 2 (US 2) |
| Service Slice B (SS B) | User Slice 1 (US 1), User Slice 4 (US 4), |
| | User Slice 5 (US 5) |
| . . . | |
| Service Slice M (SS M) | User Slice 2 (US 2), User Slice 5 (US 5), |
| | User Slice N (US N) |

As defined in Table 2, Service Slice A (SS A) corresponds to two different user slices—User Slice 1 (US 1) and User Slice 2 (US 2). What this mapping means is that if the external application service provider configures a service with service slice information ‘SS A’ (for example using the M1 provisioning API as specified in 3GPP TS 26.501 and TS 26.510), then the PDU Sessions of different users currently in user slices ‘US 1’ and ‘US 2’ are able to use the service. Similarly, when the external application service provider configures a media service with service slice ‘SS B’ (for example using the M1 provisioning API as specified in 3GPP TS 26.501 and TS 26.510), then the PDU Sessions of different users currently in user slices ‘US 1’ and ‘US 4’, and ‘US 5’ are able to use the service.

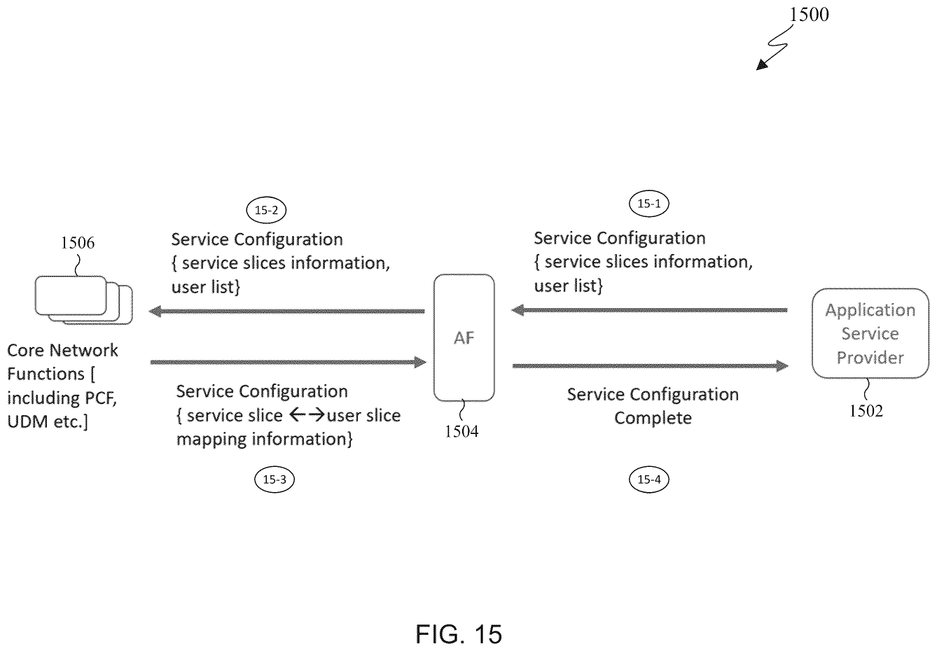

In some embodiments, the procedure for mapping the external service slices to internal UE slices as in Table 2 can as shown in FIG. 15.

FIG. 15 illustrates an example procedure for mapping external service slices to internal UE slices 1500 according to embodiments of the present disclosure. An embodiment of the procedure illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a procedure for mapping external service slices to internal UE slices could be used without departing from the scope of this disclosure.

In the example of FIG. 15, the procedure 1500 begins at step 15-1. At step 15-1, an external application provider provisions/configures the service using service slice information at the Application Function 1504 (for example using the M1 provisioning API specified in 3GPP TS 26.501 and TS 26510). The service configuration information also includes the list of users that are subscribed for the service in the form of a user list. The service slice information is based on negotiation with the network operator for allocation of network slices that satisfy the requirements of the delivery of the service that is being provisioned/configured. For example, the negotiation could use the GST and/or NEST slice templates as standardized by the GSMA standard organization.

At step 15-2, the AF 1504 processes the incoming service provisioning/configuration information, and forwards the information to the network operator internal core network functions 1506 such as the PCF, UDM, SMF etc. The internal core network functions 1506 take the service configuration information, including the service slice information and user list information, and maps them to internal UE slices based on user subscription information of the list of users in the user list.

At step 15-3, the internal core network functions 1506 respond back to the Application Function 1504 with a mapping of external service slice information and internal UE slice information (for example, in the format defined in Table 2). The core network functions 1506 may prefer to hide the actual UE slice information to be shared with the Application Function 1504. In this case, the internal core network functions may do another mapping to map the UE slice information to ‘masked/converted UE slice information’ which is then shared with the Application Function 1504. When the Application Function 1504 receives this message from the internal core network functions 1506, the Application Function 1504 has the mapping information to map the external service slice information to internal UE slice information (either the original UE slice information or the masked/converted UE slice information).

At step 15-4, the Application Function 1504 responds back the external application service provider 1502 with an acknowledgement.

Although FIG. 15 illustrates one example procedure for mapping external service slices to internal UE slices 1500, various changes may be made to FIG. 15. For example, while shown as a series of steps, various steps in FIG. 15 could overlap, occur in parallel, occur in a different order, occur any number of times, be omitted, or replaced by other steps.

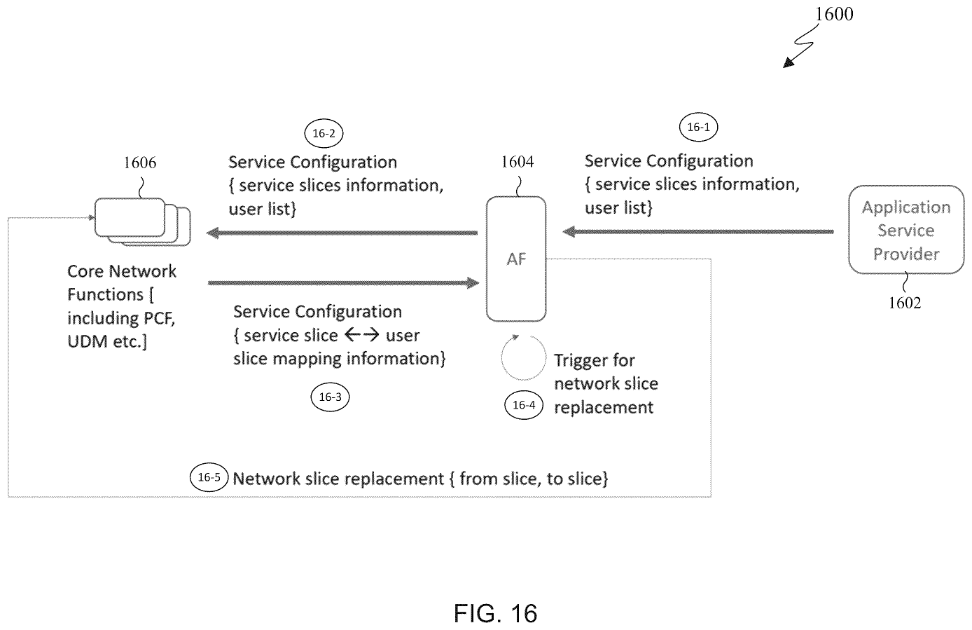

In some embodiments, an application influenced network slice change procedure may be performed based on a mapping between service slices configured by an application service provider and user slices, similar as shown in FIG. 16.

FIG. 16 illustrates an example procedure for network slice replacement based on mapping information from external service slices to internal UE slices 1600 according to embodiments of the present disclosure. An embodiment of the procedure illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of a procedure for network slice replacement based on mapping information from external service slices to internal UE slices could be used without departing from the scope of this disclosure.

In the example of FIG. 16, the procedure 1600 begins at step 16-1, where UEs have a subscription to one or more internal UE slices. At step 16-1, an application service provider 1602 provisions and configures a service (e.g., a media service) similar as described herein. The application service provider 1602 uses the service slice information during the provisioning similar as described herein.

At step 16-2, an Application Function 1604 forwards the service configuration information including the service information, user list information, etc. similar as described herein.

At step 16-3, internal core network functions 1606 prepare the mapping of service slice information to internal UE slice information, and sends it to the Application Function 1604, similar as described herein.

At step 16-4, the Application Function 1604 waits for a trigger for network slice replacement. Examples of triggers include, but are not limited to:
The Application Function 1604 receiving network slice metrics (e.g., for operator internal functions such as a Network Data Analytics Function [NWDAF]). Based on the network slice metrics, the Application Function infers that the primary network slice of the service is to be replaced.
The Application Function 1604 receiving a message or notification from operator network functions 1606 such as a NSSF, PCF because of policy reasons, AMF, OAM etc. informing the Application Function 1604 that the primary network slice is to be replaced (for example, similar as specified in 3GPP TS 23.501) (e.g., because of maintenance reasons, congestion reasons etc.).

At step 16-5, the Application Function 1604 sends a message to the core network functions 1606 for network slice replacement (for example, similar as specified in 3GPP TS 23.501, with additional steps for preparing the alternate network slice information for a given primary network slice that is being replaced described herein). When the Application Function 1604 receives the trigger for network slice replacement with primary network slice, it performs the following steps:
Extracting the service slice to user slice mapping information received in step 16-3.
Checking the list of user slices corresponding to the Service Slice that is being replaced. The list of user slices indicate to the AF 1604 what user slices are allowed during the network slice replacement procedure.
For each user, depending on the current user slice its PDU session is currently in, the AF 1604 checks if a different User Slice in the same Service Slice exists in the user subscription. If it does, then the AF 1604 uses that User Slice as the slice to which the network slice is to be replaced with.
For example, with the mapping values in Table 2, if the Application Function 164, in step 16-4 gets a trigger for network slice replacement, for example with Service Slice A (SS A), then the AF performs the following steps:

```
For each user U1:
  If U1's PDU Session is in User Slice (US 1):
    then a different User Slice in same Service Slice A (SS A) is User Slice 2
(US 2)
    then for user U1, perform network slice replacement from User Slice 1 (US
1)
    to User Slice 2 (US 2) if User U1 has a subscription for User Slice 2 (US 2)
  Otherwise: no slice replacement for User U1
```

Although FIG. 16 illustrates one example procedure for network slice replacement based on mapping information from external service slices to internal UE slices 1600, various changes may be made to FIG. 16. For example, while shown as a series of steps, various steps in FIG. 16 could overlap, occur in parallel, occur in a different order, occur any number of times, be omitted, or replaced by other steps.

In some embodiments, network slice groups may be used for selection of alternate network slices when a trigger is observed/received for network slice replacement. In embodiments such as these, network slice groups may be defined where each group comprises one or more network slices similar as shown in Table 3.

TABLE 3
Network Slice Subscription Groups for a given service slice

| Slice Subscription Group | User slices |
|---|---|
| Subscription Group A (SG A) | User Slice 1 (US 1), User Slice 3 (US 3) |
| Subscription Group B (SG B) | User Slice 1 (US 1), User Slice 2 (US 2), |
| | User Slice 3 (US 3) |
| . . . | |
| Subscription Group P (SG M) | User Slice 2 (US 2), User Slice 6 (US 6), |
| | User Slice N (US N) |

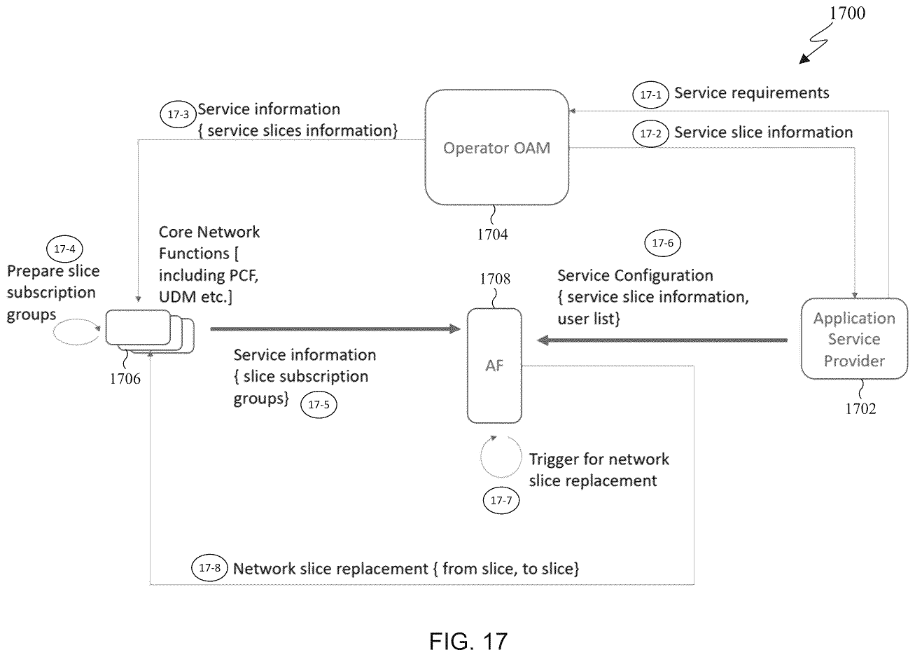

FIG. 17 illustrates an example procedure for network slice replacement based on network slice subscription groups 1700 according to embodiments of the present disclosure. An embodiment of the procedure illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of a procedure for network slice replacement based on network slice subscription groups could be used without departing from the scope of this disclosure.

In the example of FIG. 17, the procedure 1700 begins at step 17-1. At step 17-1, a 3rd party application service provider 1702 negotiates with the operator OAM 1704 (for example, similar as described herein or using other methods) on SLA requirements for the services that the application provider 1702 intends to provision/configure (e.g., using GST/NEST templates).

At step 17-2, the network operator OAM 1704 responds back to the application service provider 1702 with service slice information. The service slice information is to be used by the application service provider 1702 to request provisioning and management of service traffic.

At step 17-3, the operator OAM 1704 informs the core network internal functions 1706 about the negotiated service and the service slice information.

At step 17-4, the core network functions 1706 prepare the network slice subscription groups defined earlier for the received service information from the OAM 1704.

At step 17-5, the core network functions inform 1706 the Application Function 1708 of network slice subscription groups for the service.

At step 17-6, the application service provider 1702 provisions/configures the service at the Application Function 1708 (for example, using the M1 provisioning interface specified in 3GPP TS 26.501 and TS 26.510). The application service provider 1702 may include the service slice information received from the OAM 1704, and the user list information.

Sometime later, at step 17-7, the Application Function 1708 receives a trigger for network replacement (e.g., using the methods described herein).

At step 17-8, the Application Function 1708 requests for AF influenced network slice replacement (for example, similar as specified in 3GPP TS 23.501 and TS 23502 including additional steps for preparing the alternate network slice information for a given primary network slice that is being replaced). When the Application Function 1708 receives the trigger for network slice replacement with primary network slice, it performs the following steps:
Extracting the network slice subscription group information related to the service slice information that was received in step 17-5.
For each user, depending on the current user slice its PDU session is currently in, checking if a different User Slice in the same Slice subscription group exists in the user subscription.
If it does, then the AF 1708 uses that User Slice as the slice with which the primary network slice is to be replaced with.
For example, with the mapping values in Table 3, if the Application Function 1708, in step 17-7 above gets a trigger for network slice replacement, for example with a User Slice (US 1), then the AF 1708 performs the following steps:

```
For each user U1:
  If U1's PDU Session is in User Slice 1 (US 1):
    then a different User Slice in same Slice Subscription group (SG A) is User
Slice 3 (US3)
    then for user U1, perform network slice replacement from User Slice 1 (US
1)
    to User Slice 3 (US 3) if User U1 has a subscription for User Slice 3 (US 3)
  Otherwise: no slice replacement for User U1
```

Although FIG. 17 illustrates one example procedure for network slice replacement based on network slice subscription groups 1700, various changes may be made to FIG. 17. For example, while shown as a series of steps, various steps in FIG. 17 could overlap, occur in parallel, occur in a different order, occur any number of times, be omitted, or replaced by other steps.

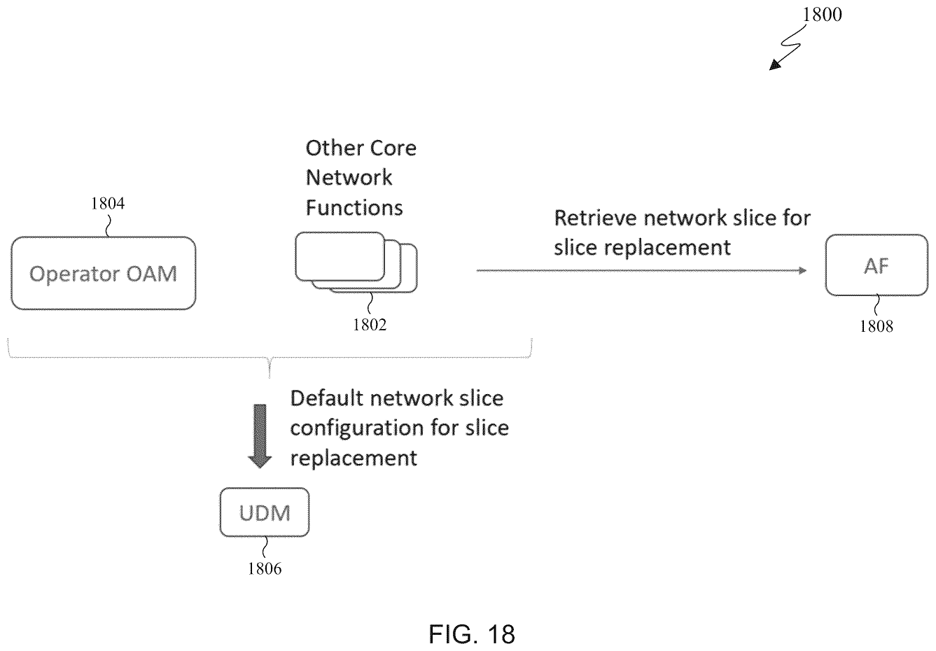

In some embodiments, a default network slice configuration may be configured by the operator network for all network slice replacement tasks, similar as shown in FIG. 18.

FIG. 18 illustrates an example of a default network slice configuration for network slice replacement 1800 according to embodiments of the present disclosure. The embodiment of configuration for network slice replacement of FIG. 18 is for illustration only. Different embodiments of a default network slice configuration for network slice replacement 1800 according to embodiments of the present disclosure. The embodiment of configuration for network slice replacement could be used without departing from the scope of this disclosure.

In the example of FIG. 18, operator network functions 1802, with assistance from operator OAM 1804, configures a default network slice for slice replacement tasks for each user separately. Such a default network slice for slice replacement persisted in subscription databases, for example maintained by network function such as UDM 1806. After such a configuration, during any service management procedures, if the network, and/or AF 1808, determine that a current primary network slice is to be replaced, then for each user, its configured default network slice for slice replacement tasks can be used as the alternate network slice that will replace the original primary network slice. In some embodiments, the example of FIG. 18 may supplement 3GPP TS 23.501 and TS 23.502, which describe procedures for network influenced network slice replacement and AF influenced network slice replacement, but do not describe how information for and alternate network slice is generated/retrieved.

Although FIG. 18 illustrates one example of a default network slice configuration for network slice replacement 1800, various changes may be made to FIG. 18. For example, various changes to core network functions could be made, etc., according to particular needs.

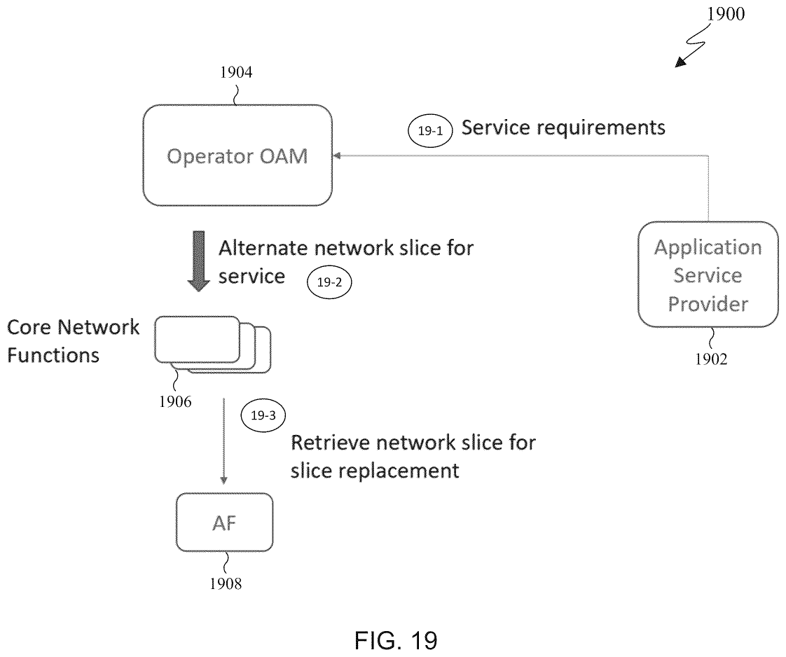

In some embodiments, an alternate network slice for slice replacement tasks can provisioned/configured by an OAM, similar as shown in FIG. 19.

FIG. 19 illustrates an example procedure for OAM provisioned/configured network slice for slice replacement 1900 according to embodiments of the present disclosure. An embodiment of the procedure illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of a procedure for an OAM provisioned/configured network slice for slice replacement could be used without departing from the scope of this disclosure.

In the example of FIG. 19, the procedure 1900 begins at step 19-1. At step 19-1, an application service provider 1902 requests network slicing services with operator OAM 1904 (for example using existing service negotiation methods such as using GST/NEST templates standardized by GSMA). As part of this request, the application service provider 1902 provides application and service requirements to the operator OAM 1904.

At step 19-2, the operator OAM 1904, apart from providing slice information to the application service provider 1902, also provisions/configures an alternate network slice for the service at the core network functions 1906. The core network functions 1906 may optionally transform/convert the provided alternate network slice to configure an alternate network slice for each of the operator users. In some embodiments, it is possible that different operator users may end up with a different alternate network slice configuration for the service.

At step 19-3, during any network slice replacement procedures (for example, similar as specified in 3GPP TS 23.501 and TS 23.502), core network functions 1906 and the AF 1908 may then use the alternate network slice configuration from step 19-2 as the alternate network slice while replacing any primary network slice.

Although FIG. 19 illustrates one example procedure for an OAM provisioned/configured network slice for slice replacement 1900, various changes may be made to FIG. 19. For example, while shown as a series of steps, various steps in FIG. 19 could overlap, occur in parallel, occur in a different order, occur any number of times, be omitted, or replaced by other steps.

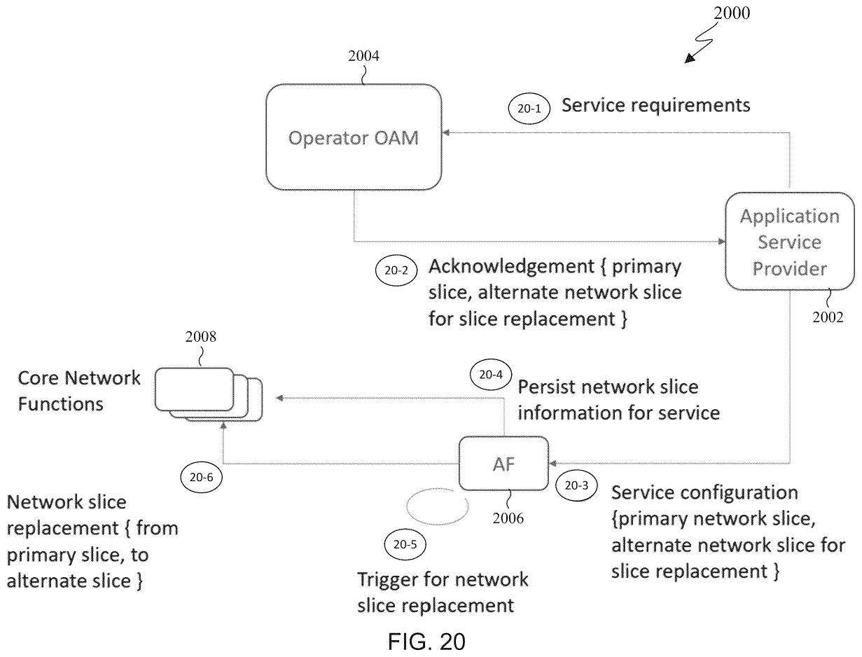

In some embodiments, an alternate network slice for slice replacement tasks can configured by an application service provider based on negotiation with an operator OAM, similar as shown in FIG. 20.

FIG. 20 illustrates an example procedure for an application service provider configured network slice for slice replacement 2000 according to embodiments of the present disclosure. An embodiment of the procedure illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a procedure for an application service provider configured network slice for slice replacement could be used without departing from the scope of this disclosure.

In the example of FIG. 20, the procedure 2000 begins at step 20-1. At step 20-1, an application service provider requests network slicing services with operator OAM 2004 (for example using existing service negotiation methods such as using GST/NEST templates standardized by GSMA). As part of this request, the application service provider 2002 provides application and service requirements to the operator OAM 2004. As part of this request, the application service provider requests operator OAM 2004 to provision both a primary network slice and an alternate network slice for slice replacement tasks. In some embodiments, the application service provider 2002 may optionally include separate service requirements for the alternate network slice for slice replacement compared to service requirements for the primary network slice.

At step 20-2, the operator OAM 2004 acknowledges the service creation request, and provisions both a primary network slice and an alternate network slice. The information about both these slices is provided back to the application service provider 2002.

At step 20-3, the application service provider 2002 proceeds to provision/configure the service it wants to provide at an Application Function 2006 in the operator network (for example, using the M1 Provisioning API specified in 3GPP TS 26.501 and TS 26.510). As part of the service configuration procedure, the application service provider 2002 may include both the primary and the alternate network slice information.

At step 20-4, the Application Function 2006 persists the network slicing information, including both the primary and alternate network slice with other core network functions 2008 such as the PCF. In some embodiments, upon receiving this information, the core network functions 2008 may optionally transform/convert the provided alternate network slice to configure an alternate network slice for each of the operator users. It is possible that different operator users may end up with a different alternate network slice configuration for the service.

Sometime later, at step 20-5, the Application Function 2006 receives or observes triggers for network slice replacement, similar as described herein.

At step 20-6, the Application Function 2006 perform the network slice replacement tasks (for example, similar as specified in TS 23501 and TS 23501 with additional steps for extracting alternate network slice information for slice replacement tasks). In some embodiments, the Application Function 2006 provides identification information of each user to core network functions 2008 with the network slice replacement message. The core network functions 2008 may then infer the alternate network slice for the user based on information prepared in step 20-4 above, and uses the inferred alternate network slice as the alternate network slice during slice replacement tasks.

Although FIG. 20 illustrates one example procedure for an application service provider configured network slice for slice replacement 2000, various changes may be made to FIG. 20. For example, while shown as a series of steps, various steps in FIG. 20 could overlap, occur in parallel, occur in a different order, occur any number of times, be omitted, or replaced by other steps.

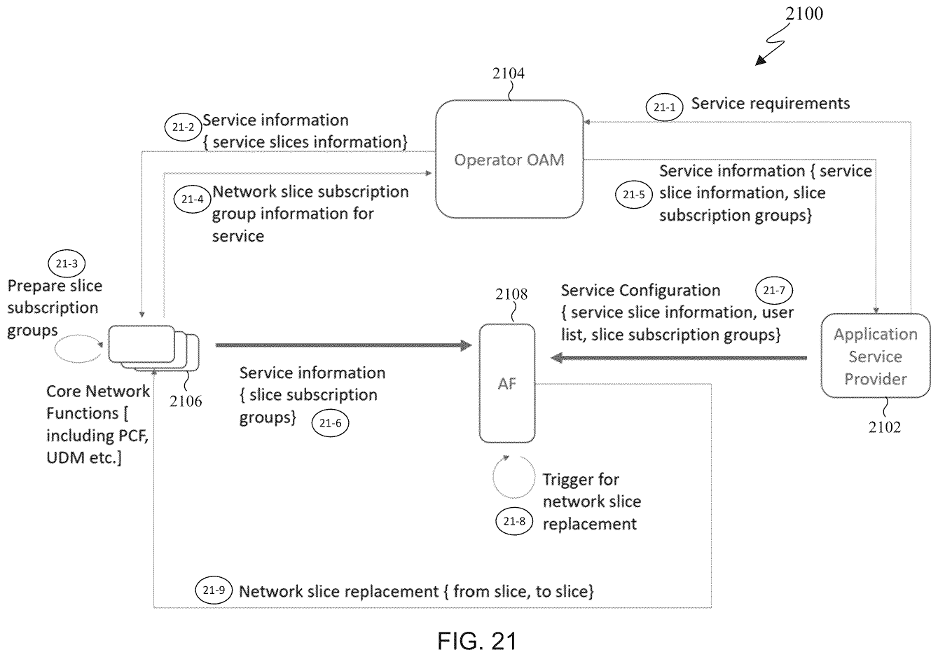

As previously described (for example, with respect to FIG. 16), in some embodiments, an AF may influence network slice replacement based on network slice subscription groups. In some embodiments, where an AF may influence network slice replacement based on network slice subscription groups, an application service provider takes a more active role than in the embodiment illustrated in FIG. 16. For example, in some embodiments, a service provisioning and configuration procedure may include a network slice replacement slice subscription group as part of the service configuration information, similar as shown in FIG. 21.

FIG. 21 illustrates an example procedure for network slice replacement based on network slice subscription groups based on configuration information from an application service provider 2100 according to embodiments of the present disclosure. An embodiment of the procedure illustrated in FIG. 21 is for illustration only. One or more of the components illustrated in FIG. 21 may be implemented in specialized circuitry configured to perform the noted functions or one or more of the components may be implemented by one or more processors executing instructions to perform the noted functions. Other embodiments of a procedure for network slice replacement based on network slice subscription groups based on configuration information from an application service provider could be used without departing from the scope of this disclosure.

In the example of FIG. 21, the procedure 2100 begins at step 21-1. At step 21-1, a 3rd party application service provider 2102 negotiates with the operator OAM 2104 (for example, similar as described herein, or using other methods) on SLA requirements for the services that the application provider 2102 intends to provision/configure (e.g., using GST/NEST templates).

At step 21-2, the operator OAM 2104 prepares the service slice information, and informs the core network internal functions 2106 about negotiated service and the service slice information.

At step 21-3, the core network functions 2106 prepare the network slice subscription groups as described herein for the received service information from the OAM 2104.

At step 21-4, the core network functions 2106 inform the operator OAM 2104 about network slice subscription groups. In some embodiments, the core network functions 2106 may use masked/converted information in the network slice subscription group if they don't want to reveal operator internal details.

At step 21-5, the network operator OAM 2104 forwards the network slice subscription group details to the application service provider 2102 with service slice information. The service slice information is to be used by the application service provider 2102 to request provisioning and management of service traffic.

At step 21-6, the core network functions 2106 inform the Application Function 2108 of network slice subscription groups for the service.

At step 21-7, the application service provider 2102 may provision/configure the service at the Application Function 2108 (for example, using the M1 provisioning interface specified in 3GPP TS 26.501 and TS 26.510). The application service provider 2102 may include the service slice information received from the OAM 2104, the user list information, and the network slice subscription groups information.

Sometime later, at step 21-8, the Application Function 2108 receives a trigger for network replacement (e.g., using the methods described herein).

At step 21-9, the Application Function 2108 requests for AF influenced network slice replacement (for example, similar as specified in TS 23501 and TS 23502 with additional steps for preparing the alternate network slice information for a given primary network slice that is being replaced). When the Application Function 2108 receives the trigger for network slice replacement with primary network slice, it performs the following steps:
Extracting the network slice subscription group information related to the service slice information that was received in step 21-6.
For each user, depending on the current User slice its PDU session is currently in, the AF 2108 checks if a different User Slice in the same Slice subscription group exists in the user subscription. If it does, then the AF 2108 uses that User Slice as the slice with which the primary network slice is to be replaced with.
For example, with the mapping values in Table 3 above in the disclosure, if the Application Function 2108, in step 21-8 above gets a trigger for network slice replacement, for example with User Slice (US 1), then the AF performs the following steps:

```
For each user U1:
  If U1's PDU Session is in User Slice 1 (US 1):
    then a different User Slice in same Slice Subscription group (SG A) is User
Slice 3 (US3)
    then for user U1, perform network slice replacement from User Slice 1 (US
1)
    to User Slice 3 (US 3) if User U1 has a subscription for User Slice 3 (US 3)
  Otherwise: no slice replacement for User U1
```

Although FIG. 21 illustrates one example procedure for network slice replacement based on network slice subscription groups based on configuration information from an application service provider 2100, various changes may be made to FIG. 21. For example, while shown as a series of steps, various steps in FIG. 21 could overlap, occur in parallel, occur in a different order, occur any number of times, be omitted, or replaced by other steps.

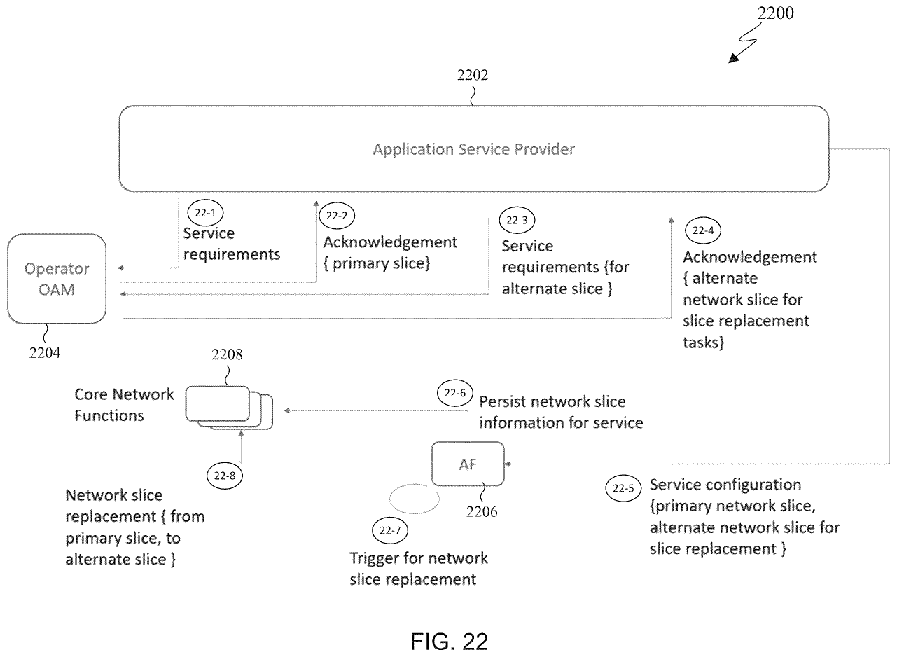

As previously described (for example, with respect to FIG. 20), in some embodiments, an alternate network slice for slice replacement tasks can configured by an application service provider based on negotiation with an operator OAM. Alternatively, in some embodiments, an alternate network slice for slice replacement tasks can configured by an application service provider based on negotiation with an operator OAM, similar as shown in FIG. 22.

FIG. 22 illustrates an example procedure for an application service provider configured network slice for slice replacement 2200 according to embodiments of the present disclosure. An embodiment of the procedure illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of a procedure for an application service provider configured network slice for slice replacement could be used without departing from the scope of this disclosure.

In the example of FIG. 22, the procedure 2200 begins at step 22-1. At step 22-1, an application service provider 2202, requests network slicing services with operator OAM 2204 (for example using existing service negotiation methods such as using GST/NEST templates standardized by GSMA). As part of this request, the application service provider 2202 provides application and service requirements to the operator OAM 2204.

At step 22-2, the operator OAM 2204 acknowledges the service creation request, and provisions a primary network slice for delivering the service.

At step 22-3, the application service provider 2202 may repeat step 23-1 above for negotiating an alternate network slice. In this request, the application service provider 2202 may optionally include a different set of service requirements for provisioning an alternate network slice.

At step 22-4, the operator OAM 2204 acknowledges the service creation request with an optionally different set of requirements for provisioning of the alternate network slice for slice replacement tasks, and provisions an alternate slice for delivering the service. The alternate network slice information is then provided to the application service provider 2202.

At step 22-5, The application service provider 2202 proceeds to provision/configure the service it wants to provide at Application Function 2206 in the operator network (for example using the M1 Provisioning API specified in 3GPP TS 26.501 and TS 26.510). In some embodiments, as part of the service configuration procedure, the application service provider 2202 may include both the primary and the alternate network slice information.

At step 22-6, the Application Function 2206 persists the network slicing information, including both the primary and alternate network slice with other core network functions 2208 such as the PCF. In some embodiments, upon receiving this information, the core network functions 2208 may optionally transform/convert the provided alternate network slice to configure an alternate network slice for each of the operator users. In some embodiments, it is possible that different operator users may end up with a different alternate network slice configuration for the service.

Sometime later, at step 22-7, Application Function 2206 receives or observes triggers for network slice replacement as described herein.

At step 22-8, Application Function 2206 performs the network slice replacement tasks (for example, similar as specified in 3GPP TS 23.501 and TS 23.501 with additional steps for extracting alternate network slice information for slice replacement tasks). In some embodiments, the Application Function 2206 provides identification information of each user to core network functions 2208 with the network slice replacement message. The core network functions 2208 may then infer the alternate network slice for the user based on information prepared in step 22-4, and use the inferred alternate network slice as the alternate network slice during slice replacement tasks.

Although FIG. 220 illustrates one example procedure for an application service provider configured network slice for slice replacement 2200, various changes may be made to FIG. 22. For example, while shown as a series of steps, various steps in FIG. 22 could overlap, occur in parallel, occur in a different order, occur any number of times, be omitted, or replaced by other steps.

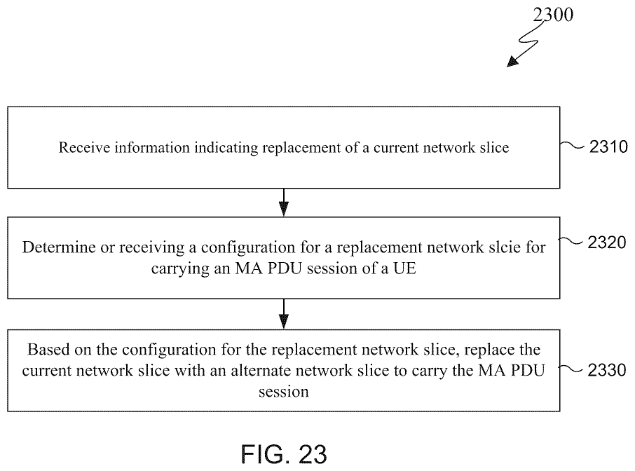

FIG. 23 illustrates an example method for network slice replacement with multi-access delivery 2300 according to embodiments of the present disclosure. An embodiment of the method illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of a method for network slice replacement with multi-access delivery could be used without departing from the scope of this disclosure.

In the example of FIG. 23, method 2300 begins at step 2310. At step 2310, an electronic device, for example operating as a network function such as the AMF 604 of FIG. 6 or another network function, receives information indicating replacement of a current network slice (for example, Slice A of FIG. 6).

At step 2320, the electronic device determines or receives (for example, from an application service provider or a network function) a configuration for a replacement network slice for carrying an MA PDU session of a UE (such as UE 602 of FIG. 6).

At step 2330, based on the configuration for the replacement network slice, The electronic device replaces the current network slice with an alternate network slice (for example, Slice B of FIG. 6) to carry the MA PDU session.

In some embodiments, (i) the current network slice may carry the MA PDU session, (ii) a configuration of the current network slice may be a single slice configuration, and (iii) the configuration for the replacement network slice may be a multi-slice configuration. In embodiments such as these, to replace the current network slice with an alternate network slice to carry the MA PDU session, the electronic device may replace the current network slice with a plurality of alternate network slices, and each alternate network slice of the plurality of alternate network slices may carry traffic of the MA PDU session over a different access network

In some embodiments, (i) the current network slice may carry a single-access (SA) PDU session over a first access network, (ii) the information indicating replacement of the current network slice may be due to a request from the UE to add at least a second access network to the SA PDU session. In embodiments such as these, traffic of the MA PDU session may correspond with traffic of the SA PDU session, and the alternate network slice may carry traffic of the MA PDU session over the first and second access network of the MA PDU session. In some embodiments, the UE request to add at least one access network to the SA PDU session may be a request to add a preferred access network to the SA PDU session. In embodiments such as these, the electronic device may (i) transmit, to the UE, a message recommending addition of an alternate access network from the preferred access network to the SA PDU session, and (ii) receive, from the UE, a decision whether to add the preferred access network or the alternate access network to the PDU session. Based on the decision received from the UE, the alternate network slice may carry one of the preferred access network or the alternate access network for the MA PDU session. when the decision from the UE is to add the alternate access network to the PDU session, the alternate network slice is the current network slice reconfigured to carry the MA PDU session.

In some embodiments, the electronic device may receive a mapping of service slice information to internal UE slice information. In embodiments such as these, to replace the current network slice with an alternate network slice to carry the MA PDU session, the electronic device may (i) extract, from the mapping of service slice information to internal UE slice information, service slice to user slice mapping information for the MA PDU session, (ii) determine, based on the mapping information for the MA PDU session, whether the UE is subscribed to a user slice that does not correspond with the MA PDU session, and is in a service slice corresponding with the MA PDU session, and (iii) replace a user slice that corresponds with the MA PDU session with the user slice that does not correspond with the MA PDU session and is in the service slice corresponding with the MA PDU session.

In some embodiments, the electronic device may receive network slice subscription group information. In embodiments such as these, to replace the current network slice with an alternate network slice to carry the MA PDU session, the electronic device may (i) extract, from the network slice subscription group information, network slice subscription group information for the MA PDU session, (ii) determine, based on the network slice subscription group information for the MA PDU session, whether the UE is subscribed to a user slice that does not correspond with the MA PDU session, and is in a service slice corresponding with the MA PDU session, and (iii) replace a user slice that corresponds with the MA PDU session with the user slice that does not correspond with the MA PDU session and is in the service slice corresponding with the MA PDU session.

In some embodiments, the configuration for the replacement network slice may include a configuration for the current network slice and a configuration for the alternate network slice. In embodiments such as these, to replace the current network slice with an alternate network slice to carry the MA PDU session, the electronic device may (i) transmit, to one or more core network functions, a network slice replacement message, (ii) receive, from the one or more core network functions, an indication of the alternate network slice, and (iii) replace the current network slice with the alternate network slice based on the indication.

In some embodiments, the configuration for the replacement network slice may be a default network slice configuration for slice replacement.

In some embodiments, the electronic device may (i) receive, as part of a negotiation with an operator operations, administration, and maintenance (OAM), the configuration for the replacement network slice, wherein the configuration for the replacement network slice includes a configuration for the current network slice and a configuration for the alternate network slice, and (ii) extract, from configuration for the replacement network slice, the configuration for the alternate network slice. In embodiments such as these, the current network slice may be replaced with the alternate network slice based on the configuration for the alternate network slice.

Although FIG. 23 illustrates one example method for network slice replacement with multi-access delivery 2300, various changes may be made to FIG. 23. For example, while shown as a series of steps, various steps in FIG. 23 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method for network slice replacement with multi-access delivery, the method comprising:
receiving information indicating replacement of a current network slice;
determining or receiving a configuration for a replacement network slice for carrying a multi-access (MA) protocol data unit (PDU) session of a user equipment (UE); and
based on the configuration for the replacement network slice, replacing the current network slice with an alternate network slice to carry the MA PDU session.

2. The method of claim 1, wherein:
the current network slice is carrying the MA PDU session;
a configuration of the current network slice is a single slice configuration;
the configuration for the replacement network slice is a multi-slice configuration;
replacing the current network slice with an alternate network slice to carry the MA PDU session comprises replacing the current network slice with a plurality of alternate network slices; and
each alternate network slice of the plurality of alternate network slices carries traffic of the MA PDU session over a different access network.

3. The method of claim 1, wherein:
the current network slice is carrying a single-access (SA) PDU session over a first access network;
the information indicating replacement of the current network slice is due to a request from the UE to add at least a second access network to the SA PDU session;
traffic of the MA PDU session corresponds with traffic of the SA PDU session; and
the alternate network slice carries traffic of the MA PDU session over the first and second access network of the MA PDU session.

4. The method of claim 3, wherein:
the UE request to add at least one access network to the SA PDU session is a request to add a preferred access network to the SA PDU session;
the method further comprises:
transmitting, to the UE, a message recommending addition of an alternate access network from the preferred access network to the SA PDU session; and
receiving, from the UE, a decision whether to add the preferred access network or the alternate access network to the PDU session; and
based on the decision received from the UE, the alternate network slice carries one of the preferred access network or the alternate access network for the MA PDU session.

5. The method of claim 4, wherein when the decision from the UE is to add the alternate access network to the PDU session, the alternate network slice is the current network slice reconfigured to carry the MA PDU session.

6. The method of claim 1, further comprising receiving a mapping of service slice information to internal UE slice information;
wherein replacing the current network slice with an alternate network slice to carry the MA PDU session comprises:
extracting, from the mapping of service slice information to internal UE slice information, service slice to user slice mapping information for the MA PDU session;
determining, based on the mapping information for the MA PDU session, whether the UE is subscribed to a user slice that (i) does not correspond with the MA PDU session, and (ii) is in a service slice corresponding with the MA PDU session; and
replacing a user slice that corresponds with the MA PDU session with the user slice that does not correspond with the MA PDU session and is in the service slice corresponding with the MA PDU session.

7. The method of claim 1, further comprising receiving network slice subscription group information,
wherein replacing the current network slice with an alternate network slice to carry the MA PDU session comprises:
extracting, from the network slice subscription group information, network slice subscription group information for the MA PDU session;
determining, based on the network slice subscription group information for the MA PDU session, whether the UE is subscribed to a user slice that (i) does not correspond with the MA PDU session, and (ii) is in a service slice corresponding with the MA PDU session; and
replacing a user slice that corresponds with the MA PDU session with the user slice that does not correspond with the MA PDU session and is in the service slice corresponding with the MA PDU session.

8. The method of claim 1, wherein:
the configuration for the replacement network slice includes a configuration for the current network slice and a configuration for the alternate network slice; and
replacing the current network slice with an alternate network slice to carry the MA PDU session comprises:
transmitting, to one or more core network functions, a network slice replacement message;
receiving, from the one or more core network functions, an indication of the alternate network slice; and
replacing the current network slice with the alternate network slice based on the indication.

9. The method of claim 1, wherein the configuration for the replacement network slice is a default network slice configuration for slice replacement.

10. The method of claim 1, further comprising:
receiving, as part of a negotiation with an operator operations, administration, and maintenance (OAM), the configuration for the replacement network slice, wherein the configuration for the replacement network slice includes a configuration for the current network slice and a configuration for the alternate network slice; and
extracting, from configuration for the replacement network slice, the configuration for the alternate network slice,
wherein the current network slice is replaced with the alternate network slice based on the configuration for the alternate network slice.

11. An electronic device comprising:
at least one processor including processing circuitry; and
memory storing instructions, wherein the instructions, when executed by the at least one processor individually or collectively, cause the electronic device to:
receive information indicating replacement of a current network slice;
determine or receive a configuration for a replacement network slice for carrying a multi-access (MA) protocol data unit (PDU) session of a user equipment (UE); and
based on the configuration for the replacement network slice, replace the current network slice with an alternate network slice to carry the MA PDU session.

12. The electronic device of claim 11, wherein:
the current network slice is carrying the MA PDU session;
a configuration of the current network slice is a single slice configuration;
the configuration for the replacement network slice is a multi-slice configuration;
to replace the current network slice with an alternate network slice to carry the MA PDU session, the instructions, when executed by the at least one processor individually or collectively, further cause the electronic device to replace the current network slice with a plurality of alternate network slices; and
each alternate network slice of the plurality of alternate network slices carries traffic of the MA PDU session over a different access network.

13. The electronic device of claim 11, wherein:
the current network slice is carrying a single-access (SA) PDU session over a first access network;
the information indicating replacement of the current network slice is due to a request from the UE to add at least a second access network to the SA PDU session;
traffic of the MA PDU session corresponds with traffic of the SA PDU session; and
the alternate network slice carries traffic of the MA PDU session over the first and second access network of the MA PDU session.

14. The electronic device of claim 13, wherein:
the UE request to add at least one access network to the SA PDU session is a request to add a preferred access network to the SA PDU session;
the instructions, when executed by the at least one processor individually or collectively, further cause the electronic device to:
transmit, to the UE, a message recommending addition of an alternate access network from the preferred access network to the SA PDU session; and
receive, from the UE, a decision whether to add the preferred access network or the alternate access network to the PDU session; and
based on the decision received from the UE, the alternate network slice carries one of the preferred access network or the alternate access network for the MA PDU session.

15. The electronic device of claim 14, wherein when the decision from the UE is to add the alternate access network to the PDU session, the alternate network slice is the current network slice reconfigured to carry the MA PDU session.

16. The electronic device of claim 11, wherein:
the instructions, when executed by the at least one processor individually or collectively, further cause the electronic device to receive a mapping of service slice information to internal UE slice information; and
to replace the current network slice with an alternate network slice to carry the MA PDU session, the instructions, when executed by the at least one processor individually or collectively, further cause the electronic device to:
extract, from the mapping of service slice information to internal UE slice information, service slice to user slice mapping information for the MA PDU session;
determine, based on the mapping information for the MA PDU session, whether the UE is subscribed to a user slice that (i) does not correspond with the MA PDU session, and (ii) is in a service slice corresponding with the MA PDU session; and
replace a user slice that corresponds with the MA PDU session with the user slice that does not correspond with the MA PDU session and is in the service slice corresponding with the MA PDU session.

17. The electronic device of claim 11, wherein:
the instructions, when executed by the at least one processor individually or collectively, further cause the electronic device to receive network slice subscription group information; and
to replace the current network slice with an alternate network slice to carry the MA PDU session, the instructions, when executed by the at least one processor individually or collectively, further cause the electronic device to:
extract, from the network slice subscription group information, network slice subscription group information for the MA PDU session;
determine, based on the network slice subscription group information for the MA PDU session, whether the UE is subscribed to a user slice that (i) does not correspond with the MA PDU session, and (ii) is in a service slice corresponding with the MA PDU session; and
replace a user slice that corresponds with the MA PDU session with the user slice that does not correspond with the MA PDU session and is in the service slice corresponding with the MA PDU session.

18. The electronic device of claim 11, wherein:
the configuration for the replacement network slice includes a configuration for the current network slice and a configuration for the alternate network slice; and
to replace the current network slice with an alternate network slice to carry the MA PDU session, the instructions, when executed by the at least one processor individually or collectively, further cause the electronic device to:
transmit, to one or more core network functions, a network slice replacement message;
receive, from the one or more core network functions, an indication of the alternate network slice; and
replace the current network slice with the alternate network slice based on the indication.

19. The electronic device of claim 11, wherein the configuration for the replacement network slice is a default network slice configuration for slice replacement.

20. The electronic device of claim 11, wherein the instructions, when executed by the at least one processor individually or collectively, further cause the electronic device to:
receive, as part of a negotiation with an operator operations, administration, and maintenance (OAM), the configuration for the replacement network slice, wherein the configuration for the replacement network slice includes a configuration for the current network slice and a configuration for the alternate network slice; and
extract, from configuration for the replacement network slice, the configuration for the alternate network slice,
wherein the current network slice is replaced with the alternate network slice based on the configuration for the alternate network slice.
